(19) United States
(12) Patent Application Publication
(10) Pub. No.: US 2009/0065736 A1
(43) Pub. Date: Mar. 12, 2009

(54) CHEMICAL MODIFICATION OF MALEATED FATTY ACIDS

(75) Inventors: Roger Scott Johnson, Snellville, GA (US); Phillip W. Hurd, Conyers, GA (US); John B. Hines, Atlanta, GA (US); Brett Neumann, Covington, GA (US)

Correspondence Address: PATENT GROUP GA30-43;GEORGIA-PACIFIC LLC, 133 PEACHTREE STREET, NE, ATLANTA, GA, 30303, US

(73) Assignee: GEORGIA-PACIFIC CHEMICALS LLC, Atlanta, GA (US)

(21) Appl. No.: 12/166,387

(22) Filed: Jul. 2, 2008

Related U.S. Application Data
(60) Provisional application No. 60/947,811, filed on Jul. 3, 2007.

(51) Int. Cl. C09F 7/10; C09K 3/00; C09K 3/22; C04B 24/08; B01F 3/08; C02F 1/54

(52) U.S. Cl. 252/88.1; 530/232; 530/231; 252/396; 252/395; 252/394; 252/390; 106/661; 516/9; 210/723

(57) ABSTRACT

Chemically modified maleated fatty acid compositions and the salts thereof, especially chemically modified tall oil fatty acid containing compositions are useful in formulating corrosion inhibitors, as emulsifiers, as collectors in mining applications, and as cross-linking agents, such compositions find particular utility for petroleum-related applications.

### CROSS-REFERENCE TO RELATED APPLICATIONS

This application claims the benefit of and incorporates by reference co-pending provisional application Ser. No. 60/947,811 filed Jul. 3, 2007.

### FIELD OF THE INVENTION

The present invention broadly relates to products obtained by chemically modifying maleated fatty acids. The present invention particularly relates to a variety of chemically modified maleated tall oil fatty acid-containing products. Such products are useful, especially for petroleum-related applications, in formulating corrosion inhibitors and as emulsifiers and also are useful as cross-linking agents and as collectors in mining applications.

### BACKGROUND OF THE INVENTION

Catalytic (thermal) polymerization of tall oil fatty acids produces a product known as dimer/trimer acid which the oil industry has traditionally employed as a component of oil-soluble corrosion inhibitors for reducing corrosion in oil well piping and related recovery equipment. The thermal polymerization causes the C₁₈ tall oil fatty acids (containing one or two double bonds, e.g., oleic and linoleic acids, respectively), in the presence of a suitable catalyst, to give varying amounts of C₃₆ (dimerized) and C₅₄ (trimerized) fatty acids. These dimer and/or trimer fatty acids may be neutralized with an appropriate amine, such as diethylenetriamine, to produce a corrosion inhibitor. The dimer/trimer acid-based product is said to inhibit corrosion by coating metal surfaces with a thin hydrophobic film, thereby excluding the water necessary for corrosion processes to occur.

Over the years, the corrosion inhibition art has looked for alternatives to dimer/trimer acid-based products. Of particular interest in this regard is the class of fatty acid-based products which have been functionalized with maleic anhydride and/or fumaric acid.

Thus, according to U.S. Pat. No. 4,927,669, tall oil fatty acid (TOFA) is functionalized using maleic anhydride, or fumaric acid, in the presence of a catalyst such as iodine, clay or silica. The fatty acids are reacted in a first step to promote a Diels-Alder reaction with linoleic acid, the product then being distilled to remove unreacted fatty acid. In a second step, non-conjugated acid, e.g., oleic/elaidic acids, are treated under more vigorous conditions to form an ene adduct. Residual unreacted fatty acid is removed. The separate products are preferably blended together to provide a composition, which is said to contain 75 to 95% maleinized fatty acids, 15 to 20% thermal dimer and trimer and remaining unreacted fatty acid, useful as a corrosion inhibitor. U.S. Pat. No. 4,927,669 also notes that a typical corrosion inhibitor package contains an equal amount (by weight) of the maleated fatty acid component and a fatty acid imidazoline (e.g., Witcamine 209 or 211).

U.S. Pat. No. 5,292,480 condenses the maleic anhydride-functionalized TOFA of U.S. Pat. No. 4,927,669 with a polyalcohol, such as ethylene glycol, diethylene glycol, triethylene glycol, polyethylene glycol, glycerin, pentaerythritol, trimethylolpentane, and sorbitol to form an acid-anhydride ester corrosion inhibitor, which in turn may be neutralized with an amine, with a metal oxide, or with a hydroxide before use. U.S. Pat. No. 5,385,616 is similar in describing the reaction product of the maleic anhydride-functionalized TOFA of U.S. Pat. No. 4,927,669 and an alcohol (ROH).

U.S. Pat. No. 4,658,036 describes reacting a maleated TOFA molecule, such as the Diels-Alder adduct of linoleic acid, sequentially with diethylenetriamine under conditions suitable for forming a cyclic imide (and using an excess of amine moieties to maleate moieties) and then reacting the free amino group of the imide with additional TOFA.

In U.S. Pat. No. 5,582,792, the maleic anhydride-functionalized TOFA is esterified (as in U.S. Pat. No. 5,385,616) and then is neutralized with an ethoxylated amine, such as an ethoxylated fatty amine to form the corresponding salt. The composition is disclosed as being useful for corrosion inhibition.

U.S. Pat. No. 5,759,485 describes a class of water soluble corrosion inhibitors in which the maleic anhydride-functionalized TOFA (specifically the Diels-Alder reaction adduct with linoleic acid) is neutralized with aminoethylethanolamine and also with one of imidazoline, amidoamine or a combination thereof. Canadian Pat. 2,299,857 describes a similar corrosion inhibitor made by reacting (neutralizing) maleated TOFA with alkanolamines.

As evidenced by the foregoing prior art attempts to develop corrosion inhibitors based on maleated TOFA, those skilled in the art continue to explore new techniques and compositions for using tall oil-related raw materials in manufacturing new corrosion inhibitors and other products.

### SUMMARY OF THE INVENTION

In one embodiment, the present invention provides chemically modified, maleated unsaturated fatty acids, the salts thereof and compositions containing them, wherein the chemical modification is selected from the group consisting of (1) esterification of said maleated unsaturated fatty acids with ricinoleic acid, (2) amidation of said maleated unsaturated fatty acids using a polyamine supplied in an amount sufficient to cause cross linking between maleated fatty acid molecules, (3) a combination of esterification and amidation of said maleated unsaturated fatty acids using an amino alcohol supplied in an amount sufficient to cause cross linking between maleated fatty acid molecules, (4) esterification of said maleated unsaturated fatty acids with an alkynyl alcohol (acetylenic alcohol) selected from propargyl alcohol, 1-hexyn-3-ol, 5-decyne-4,7-diol, oxyalkylated propargyl alcohol and mixtures thereof, (5) amidation of the maleated unsaturated fatty acids with morpholine, (6) amidation of the maleated unsaturated fatty acids with a fatty imidazoline, (7) esterification of said maleated unsaturated fatty acids with a phosphate ester, (8) reaction of the maleated unsaturated fatty acids with a metal chelator (metal chelator modification), (9) reaction of the maleated unsaturated fatty acids with an amino acid, (10) xanthate modification, (11) thiophosphate ester modification, (12) hydroxamic acid modification, (13) sulfonate modification, (14) sulfate modification and combinations thereof.

In one embodiment, the chemically modified, maleated unsaturated fatty acid of the preceding paragraph has an acid number of at least 50 mg KOH/g before any acid moieties are neutralized (i.e., before neutralization and salt formation).

In another embodiment, the present invention also is directed to the composition of the previous two paragraphs wherein the chemically modified, maleated unsaturated fatty acid has an average molecular weight greater than about 820.

In another embodiment, the present invention also is directed to the composition of any of the previous three paragraphs wherein the chemically modified, maleated unsaturated fatty acid, before neutralization, has an acid value between 50 mg KOH/g and 300 mg KOH/g.

In another embodiment, the present invention also is directed to the composition of any of the previous four paragraphs wherein the maleated unsaturated fatty acid is amidated using a polyamine at a temperature between 50° C. and about 200° C.

In another embodiment, the present invention also is directed to the composition of any of the previous five paragraphs wherein the unsaturated fatty acids comprise unsaturated C₁₈ fatty acids.

In another embodiment, the present invention also is directed to the composition of any of the previous six paragraphs wherein the unsaturated fatty acids comprise a tall oil composition containing tall oil fatty acid.

In another embodiment, the present invention also is directed to the composition of any of the previous seven paragraphs wherein the unsaturated fatty acids comprise a tall oil composition containing a tall oil rosin acid.

In another embodiment, the present invention also is directed to the composition of any of the previous eight paragraphs wherein the maleated fatty acids have been maleated with maleic anhydride.

In another embodiment, the present invention also is directed to the composition of any of the previous nine paragraphs wherein the maleated fatty acids have been maleated with from about 2% to about 25% by weight of maleic anhydride.

In other embodiments, the present invention provides methods for making chemically modified, maleated unsaturated fatty acids and the salts thereof, by reacting a source of a maleated unsaturated fatty acid with one or more of the following modifying agents (1) ricinoleic acid, (2) a polyamine, (3) an amino alcohol, (4) an alkynyl alcohol (acetylenic alcohol) selected from propargyl alcohol, 1-hexyn-3-ol, 5-decyne-4,7-diol, oxyalkylated propargyl alcohol and mixtures thereof, (5) morpholine, (6) a fatty imidazoline, (7) a phosphate ester, (8) a metal chelator, (9) an amino acid, (10) a xanthate, (11) a thiophosphate ester, (12) hydroxamic acid or hydroxamic acid precursors, (13) a sulfonate, and (14) a sulfate.

In still other embodiments, the present invention provides methods of using the chemically modified, maleated unsaturated fatty acids and the salts thereof of any of the previous paragraphs as emulsifiers, as corrosion inhibitors, as cross-linking agents, as a cementitious, e.g., concrete, adjuvant (fluid flow aid), as a dust control adjuvant, as an antistrip agent for asphalt, and as an adjuvant for solids separations from liquids, e.g., as a collector in flotation separations.

In particular, in one embodiment, the present invention provides a process for emulsifying a material comprising agitating the material in a suitable liquid in the presence of any of the compositions of the chemically modified, maleated unsaturated fatty acid or a salt thereof enumerated above.

In one embodiment, the present invention is directed to a solids separation process, including a flotation process, for separating a valued material from an aqueous solution, suspension or dispersion containing the valued material comprising adding to the aqueous solution, suspension or dispersion any of the compositions of the chemically modified, maleated unsaturated fatty acid or a salt thereof enumerated above.

In one embodiment, the present invention is directed to a process for reducing corrosion comprising contacting a material in need of corrosion protection with any of the compositions of the chemically modified, maleated unsaturated fatty acid or a salt thereof enumerated above.

In one embodiment, the present invention is directed to a process for suppressing airborne dust comprising contacting a dust generating surface with any of the compositions of the chemically modified, maleated unsaturated fatty acid or a salt thereof enumerated above.

In one embodiment, the present invention is directed to a process for reducing the viscosity of a cementitious slurry comprising adding any of the compositions of the chemically modified, maleated unsaturated fatty acid or a salt thereof enumerated above to the slurry.

These and other embodiments are set forth in the following description. Still other embodiments will be apparent to those of ordinary skill in the art after consideration of the specification.

### DETAILED DESCRIPTION OF THE INVENTION

The present invention relates to methods for preparing modified fatty acid compositions, and especially modified tall oil fatty acid (TOFA) compositions suitable for a variety of uses.

The invention particularly relates to products obtained by chemically modifying maleated fatty acids and especially relates to products obtained by chemically modifying maleated tall oil fatty acid (TOFA) containing compositions. Such products should be useful in formulating corrosion inhibitors, as emulsifiers, as cross-linking agents, as mining collectors and as an antistrip agent for asphalt, and are especially useful in petroleum-related applications such as oil well applications. The present invention also relates to the resulting compositions produced by such methods and the use of these compositions in such applications.

As used throughout the specification and in the claims the terms “maleated”, “maleation” and the like refer to the modifications of unsaturated fatty acid molecules, especially unsaturated C₁₈-fatty acids, such as linoleic acid, oleic acid and elaidic acid and their mixtures, e.g., TOFA-containing compositions, which introduce additional carboxylic moieties (or the related anhydride structure) onto the unsaturated fatty acid molecules by reaction of the unsaturated fatty acid with one or more of an α,β unsaturated carboxylic acid or anhydride, e.g., maleic anhydride. The α,β unsaturated carboxylic acid or anhydride can be a biogenically derived α,β unsaturated carboxylic acid or anhydride. Non-limiting examples of biogenically derived α,β unsaturated carboxylic acids or anhydrides include itaconic acid, itaconic anhydride, aconitic acid, aconitic anhydride, acrylic acid, methacrylic acid, citraconic acid, citraconic anhydride, mesaconic acid, muconic acid, glutaconic acid, methylglutaconic acid, traumatic acid, and fumaric acid. The acids and anhydrides include any isomers (e.g. enantiomers, diastereomers, and cis-/trans-isomers), and salts. In some embodiments, the α,β unsaturated carboxylic acid and anhydride can be one the following unsaturated acids, maleic anhydride, maleic acid, fumaric acid, acrylic acid, methacrylic acid and their mixtures.

Thus a “maleated” unsaturated fatty acid material or composition includes as non-limiting examples a tall oil that has been maleated, i.e., reacted with an α,β unsaturated carboxylic acid or anhydride; an animal oil that has been maleated; a vegetable oil that has been maleated; an algal-derived oil that has been maleated, and a microbially derived oil that has been maleated.

As used throughout this application and in the claims, the terms carboxylic or carboxyl moiety and carboxylic or carboxyl moieties are intended to embrace not only the classical—COOH group, but also an anhydride structure formed by the condensation reaction between two carboxyl groups. It should be understood that such carboxylic moities when neutralized form the related salt forms of such structures.

Also, acrylic acid and methacrylic acid are hereinafter generally referred to in the aggregate, or in the alternative as (meth)acrylic acid.

As used herein, “tall oil fatty acid” or “TOFA”, consistent with industry standards, encompasses compositions which include not only fatty acids, but also rosin acids and/or unsaponifiables. TOFAs are generally produced as a distillation fraction of crude tall oil and therefore contain a mixture of saturated and unsaturated fatty acids, rosin acids, and mixtures thereof.

For reasons discussed in more detail hereafter, specifically using maleic anhydride is generally preferred for maleating fatty acids, such as TOFA-containing compositions, to produce maleated fatty acid compositions. In order to be clear about the meaning or intent in any particular context, this application will specifically use such phrases as “maleated with maleic anhydride,” or “maleic anhydride maleation” and the like if the maleation of the fatty acid(s) is to be limited just to use of maleic anhydride. Otherwise, consistent with the above definitions, maleation is intended to embrace the use of any α,β unsaturated carboxylic acid or anhydride.

While the present invention is broadly directed to the chemical modification of a variety of maleated unsaturated fatty acid materials, the invention is particularly aimed at chemically modifying maleated tall oil products containing such maleated unsaturated fatty acids, and especially the chemical modification of tall oil products maleated with maleic anhydride.

A “chemically modified maleated unsaturated fatty acid compound” refers to a chemical compound, or a salt thereof, having a backbone comprising the residue of an unsaturated fatty acid, wherein the unsaturated fatty acid has been both (1) maleated with an α,β unsaturated carboxylic acid or anhydride and (2) chemically modified using at least one of the techniques enumerated hereafter.

A “chemically modified maleated unsaturated fatty acid composition” is simply a composition containing one or more chemically modified maleated unsaturated fatty acid compounds.

In contrast to the prior art, where there apparently has been a concerted effort to use tall oil materials containing primarily, if not almost exclusively, tall oil fatty acids (TOFA) and to conduct the reaction with maleic anhydride in a way to promote the formation of the Diels-Alder reaction adduct with linoleic acid (generally by using a catalyst), the present inventors have found such restrictions are not necessary. Thus, tall oil products containing both fatty acid and rosin acid components can be used as a suitable starting material for making a maleated fatty acid material that then is modified in accordance with the present invention. These starting materials will be referred to as tall oil fatty acid containing compositions, or TOFA-containing compositions and thus embrace compositions composed of primarily TOFA and compositions containing both TOFA and other materials such as rosin acids.

In particular, the inventors have found that suitable maleated unsaturated fatty acid starting materials can be made using a variety of tall oil products that contain unsaturated fatty acids, including crude tall oil, i.e., tall oil that contains both rosin acids and fatty acids, blended tall oil products containing both rosin acids and fatty acids, distilled tall oil products and tall oil fatty acid (TOFA). Such maleated fatty acid starting materials are amenable to subsequent chemical modification in accordance with the present invention for preparing functionalized material suitable for use as, or for producing materials suitable for use as emulsifiers, dedusting agents, viscosity control agents, corrosion inhibitors, cross-linking agents, mining collectors, asphalt antistrip agents and the like.

As a general rule, any oil containing a significant amount of unsaturated fatty acids, and particularly an oil containing C₁₈ unsaturated fatty acids, should be suitable as a source of the fatty acid-containing starting materials for making maleated unsaturated fatty acid compounds and compositions used in connection with the present invention. Thus, suitable fatty acids may be obtained from tall oil, vegetable oils, animal oils, algal-produced oils, microbial-produced oils and mixtures thereof.

As a representative, though not an exclusive or exhaustive list of possible oils that can be used as a source of unsaturated fatty acids for preparing the maleated fatty acid-containing compounds and compositions, which are then suitable as a starting material for chemical modification in connection with the present invention, can be mentioned the following: linseed (flaxseed) oil, tung oil, soybean oil, rapeseed oil, cottonseed oil, olive oil, castor oil, coco butter, crambe oil, safflower oil, canola oil, corn oil, sunflower seed oil, coconut oil, peanut oil, safflower oil, tall oil, palm oil, tallow, lard, yellow grease, fish oil (e.g., herring oil, menhaden oil and sardine oil) and mixtures thereof. Indeed, any naturally occurring oil, or a synthetic oil, which contains a fatty acid having unsaturated linkages (unsaturated fatty acid) is potentially suitable as a starting material for the maleation reaction(s).

It may also be suitable in some cases to use the distillation products of such oils or their distillation residues. In this regard, specific mention can be made of distilled tall oil and tall oil bottoms. These oils generally contain as one significant constituent linoleic acid, an unsaturated long chain fatty acid and may also contain other unsaturated fatty acids and rosin acids.

These oils can be maleated directly, or if present in a combined form such as triglycerides, can be saponified to their component fatty acids before the maleation reactions. Processing such materials to obtain the unsaturated fatty acid and the related maleated fatty acid compositions is within the skill of the art.

Fatty acids suitable for use in the present invention (found in such oils) have double bonds, i.e., sites of unsaturation in their hydrocarbon chains. As a result, such sources of fatty acids often are referred to as unsaturated oils and unsaturated fatty acids.

Use of a tall oil material (also referred to as a TOFA containing composition) is generally favored as a starting material for the present invention based on considerations of its cost, availability and performance. As is known in the art, tall oil refers to the resinous yellow-black oily liquid obtained as an acidified byproduct in the Kraft or sulfate processing of pine wood. Tall oil, prior to refining, is normally a mixture of rosin acids, fatty acids, sterols, high-molecular weight alcohols, and other alkyl chain materials. Distillation of crude tall oil is often used to recover a mixture of fatty acids in the C16-C20 range. The commercially available tall oil products XTOL®100, XTOL®300, and XTOL®304 (all from Georgia-Pacific Chemicals LLC, Atlanta, Ga.), for example, all contain saturated and unsaturated fatty acids in the C16-C20 range, as well as minor amounts of rosin acids. It is understood by those skilled in the art that tall oil is derived from natural sources and thus its composition varies among the various sources.

To prepare a maleated fatty acid and especially a maleated tall oil, an unsaturated fatty acid-containing material, such as a tall oil distillate component, is reacted with at least one α,β unsaturated carboxylic acid or anhydride such as one of maleic anhydride, maleic acid, fumaric acid, (meth)acrylic acid or a mixture thereof. For reasons discussed hereafter, the maleation reactions are often conducted using maleic anhydride. Representative tall oil distillate components include tall oil fatty acids, and mixtures of tall oil fatty acids with tall oil rosin acids. The refinement (i.e., fractionation) of tall oil can, for example, provide a product enriched with C₁₆-C₁₈ saturated and unsaturated fatty acids, as well as products containing fatty acid/rosin acid mixtures.

In preparing a maleated tall oil, tall oil distillate components, lighter (i.e., lower boiling) or heavier (i.e., higher boiling) components, or components having broader or narrower boiling point ranges may be used in the maleation reaction(s). Mixtures or blends of various tall oil distillate fractions may also be employed as the tall oil material. Fatty acid/rosin acid mixtures in a desired ratio may be obtained in a single distillate fraction by adjusting tall oil fractionation conditions. Representative tall oil distillate components include the previously mentioned, commercially available products XTOL®100, XTOL®300, and XTOL®304, and XTOL®530, and LYTOR®100 (all from Georgia-Pacific Chemicals LLC, Atlanta, Ga.).

In certain embodiments, the unsaturated fatty acid material can be maleated from about 2% to about 40% by weight, (e.g., 2%, 3.5%, 5%, 6%, 7.5%, 8%, 10%, 12%, and 15%). In some embodiments, the percent maleation is from about 2% to about 25% by weight. In one embodiment, the percent maleation is 3.5% by weight, while in another embodiment, the percent maleation is 12% by weight. In some embodiments, the percent maleation is 5% by weight. In some embodiments, the percent maleation is 6% by weight. The specific composition of products prepared or obtained is related to the percent maleation performed.

For example, a mixture of a first tall oil distillate fraction comprising predominantly tall oil fatty acids (e.g., XTOL®100) and a second tall oil distillate fraction comprising predominantly rosin acids (e.g., LYTOR®100) may be blended in a wide range of proportions as a raw material for the maleation reactions. In such mixtures, representative amounts of fatty acids and rosin acids may range from about 45% to about 90% by weight and from about 55% to about 10% by weight, respectively. Representative weight ratios of the first tall oil distillate fraction to the second tall oil distillate fraction may range from about 3:2 to about 4:1. If such a blend is used to form a maleated tall oil starting material, suitable amounts of the maleic anhydride (or other α,β unsaturated carboxylic acid(s) or anhydride(s) or mixtures thereof) may range from about 2% to about 25% by weight, usually from about 2% to about 15% by weight, based on the combined weight of the tall oil fractions and the maleic anhydride (or other α,β unsaturated carboxylic acid(s) or anhydride(s) or mixtures thereof) for the maleation reaction(s). In the case where the maleation is conducted specifically with maleic anhydride, at the 25% by weight maleation level, one is essentially performing the maleation at a 1:1 mole ratio of maleating agent and fatty acid.

Depending on the tall oil composition and fractionation conditions, a single tall oil distillate fraction may also suffice to yield a composition that is substantially the same as any of the blends of tall oil distillate fractions discussed above.

In preparing a maleated tall oil by the reaction of a tall oil material, such as tall oil distillate components, with at least one α,β unsaturated carboxylic acid or anhydride, such as one or more of maleic anhydride, maleic acid, fumaric acid, acrylic acid and methacrylic acid, a reaction temperature generally from about 150° C. (300° F.) to about 250° C. (480° F.), often from about 200° C. (390° F.) to about 230° C. (445° F.), and more often from about 215° C. (420° F.) to about 225° C. (435° F.), is used. Use of a catalyst is generally optional, i.e. it is not normally needed. Catalysts that can optionally be used are known in the prior art. Some of the representative maleation reactions that can occur are illustrated in U.S. Pat. No. 4,927,669. Preparation of other maleated unsaturated fatty acid-containing materials proceeds in an analogous manner, as well-understood by a skilled worker.

Such maleated tall oil products also can be directly obtained commercially as XTOL®690 and XTOL®692 (from Georgia-Pacific Chemicals LLC, Atlanta, Ga.).

In general, the maleation reactions involving the unsaturated fatty acid material are typically complete after a reaction time of from about 5 hours to about 36 hours, and typically after a period of time of from about 20 hours to about 30 hours. Without being bound by theory, the α,β unsaturated carboxylic acid or anhydride, such as maleic anhydride, maleic acid, fumaric acid, acrylic acid, methacrylic acid and/or mixtures thereof, reacts with the unsaturated fatty acid material, such as the tall oil distillate components at various sites of unsaturation (i.e., at carbon-carbon double bonds), present in the reactants. For example, the reaction of maleic anhydride with an unsaturated tall oil fatty acid results in the addition of the anhydride ring to the acid at olefinic sites via the so-called “ene” reaction. The reaction of maleic anhydride with a rosin acid derived from tall oil occurs at diolefinic sites and with conjugated fatty acids, may alternatively form a Diels-Alder addition product having a 6-membered ring with one residual site of unsaturation.

The maleation step involves reaction of the hydrocarbon-based structures in the fatty acid composition with one or more α,β unsaturated carboxylic acids or anhydrides. The amount of α,β unsaturated carboxylic acid or anhydride used varies based on the composition to be maleated. Suitable amounts of the anhydride (or α,β unsaturated carboxylic acid(s)) may range from about 2% to about 40% by weight, based on the combined weight of the composition and the anhydride (or α,β unsaturated carboxylic acid(s)) and/or the desired amount of maleation. In some embodiments, the amount of anhydride (or α,β unsaturated carboxylic acid(s)) can range from about 2% to about 25% by weight, usually from about 2% to about 15% by weight, based on the combined weight of the composition and the anhydride (or α,β unsaturated carboxylic acid(s)) and/or the desired amount of maleation. In some embodiments, the α,β unsaturated carboxylic acid or anhydride is chosen from maleic anhydride, fumaric acid, or (meth)acrylic acid. In some embodiments, the α,β unsaturated carboxylic acid or anhydride is a biogenically derived unsaturated carboxylic acid or anhydride. The composition of products prepared is related to the percent maleation performed.

The maleated unsaturated fatty acid material comprises a hydrocarbon-based backbone structure substituted by at least one α,β unsaturated carboxylic acid or anhydride. The hydrocarbon backbone structure can be chosen from, for example, substituted and unsubstituted straight-chain, branched-chain and polycyclic hydrocarbons. The hydrocarbon backbone structure can be chosen, for example from fatty acids. The hydrocarbon backbone structure can be chosen from, for example C₁₀-C₂₂ fatty acids. The hydrocarbon backbone structure can be chosen from, for example, C₁₆-C₂₂ fatty acids. The hydrocarbon backbone structure can be chosen from, for example, C₁₆-C₁₈ fatty acids. The hydrocarbon backbone structure can be, for example a C₁₈ fatty acid. The hydrocarbon backbone structure can be chosen from, for example oleic, linoleic, and linolenic acid.

A representative set (and by no means an exclusive list) of structures of molecular species potentially found in maleated tall oil compositions (especially tall oil compositions maleated with maleic anhydride) suitable for use as the starting material for making chemically modified maleated fatty acids of the present invention include the Diels-Alder reaction product with conjugated linoleic acid and ene reaction products with oleic acid as follows:

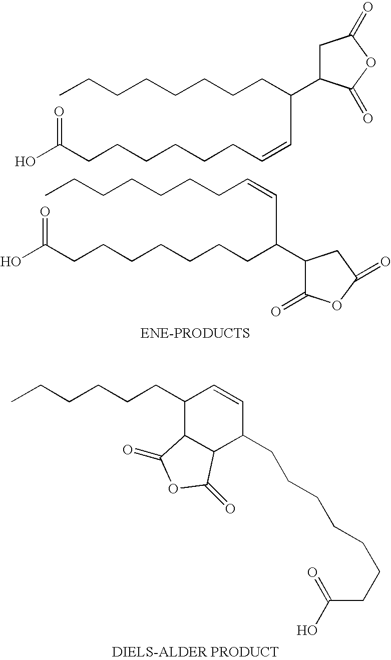

As will be appreciated by those skilled in the art, certain analogous structures are formed when using other α,β unsaturated carboxylic acids or anhydrides, such as fumaric acid, maleic acid, and/or (meth)acrylic acid for these maleation reactions.

Thus, non-limiting examples of maleated fatty acids include: maleated decenoic acid; maleated dodecenoic acid; maleated cis-9-tetradecenoic acid; maleated oleic acid; maleated linoleic acid; maleated linolenic acid; maleated cis-6,cis-9,cis-12,cis-15-octadecatetraenoic acid; maleated ricinoleic acid; maleated cis-9-eicosenoic acid; maleated cis-11-eicosenoic acid; maleated eicosadienoic acid; maleated eicosatrienoic acid; maleated arachidonic acid, maleated eicosapentaenoic acid, maleated erucic acid; maleated docosadienoic acid; maleated 4,8,12,15,19-docosapentaenoic acid; maleated docosahexaenoic acid; and maleated tetracosenoic acid.

As suggested by the above-noted representative maleation products, in practicing the present invention it is not necessary to focus only on the production of the Diels-Alder reaction adduct with conjugated fatty acids, such as conjugated linoleic acid. Thus, the conditions under which the maleation is conducted do not need to be controlled (e.g., a catalyst is not necessary) such that the Diels-Alder reaction predominates.

The present invention contemplates a variety of approaches for chemically modifying maleated fatty acids in accordance with the present invention. As will be appreciated by those skilled in the art from the representative molecules produced by such chemical modifications (as hereinafter illustrated), the chemically modified maleated fatty acid structures according to the present invention can have a higher carboxylic functionality than the prior art dimer/trimer acids, yet may be produced at a similar molecular weight. This higher carboxylic function enhances the suitability of such molecules for use as mining collectors and as a viscosity control adjuvant for cementitious slurries, such as for Portland cement slurries and for aqueous slurries of calcined gypsum; it enhances the salt or soap formation of the compositions (important to their use as emulsification aides) and also would be expected to give the compositions a stronger film persistency on metal surfaces (important for corrosion inhibition applications for example).

With the maleated fatty acid as a starting material, especially a maleated tall oil fatty acid (TOFA) containing composition, and most often a maleated tall oil fatty acid (TOFA) containing composition maleated with maleic anhydride, the present invention contemplates a variety of possible avenues for chemical modification. It is a feature of the present invention that compositions prepared as hereinafter described containing chemically modified, maleated unsaturated fatty acid materials will typically contain at least about 20% by weight, usually 25% by weight, more usually 30% by weight, often at least 35% by weight, most often at least 40% by weight, and very often at least 50% by weight (i.e., a major proportion of the composition) of the chemically modified specie(s) according to the present invention.

Provided herein are chemically modified maleated unsaturated fatty acid compounds and compositions.

In some embodiments, chemically modified, maleated unsaturated fatty acid compounds and compositions include ricinoleic acid modified maleated unsaturated fatty acid compounds and compositions.

In some embodiments, chemically modified, maleated unsaturated fatty acid compounds and compositions include polyamine modified maleated unsaturated fatty acid compounds and compositions, including compounds and compositions modified using diethylenetriamine, triethylenetetramine, polylysine, Jeffamines®, dipropylenetriamine, triproplyenetetraamine, 1,2-bis(3-aminopropylamino)ethane, bis(hexamethylene)triamine, 1,3-propanediamine, and biogenic polyamines, such as cadaverine, putrascine, spermine, spermidine, histamine, tryptamine, agmatine, cytosine, and serotonin.

In some embodiments, chemically modified, maleated unsaturated fatty acid compounds and compositions include amino alcohol modified maleated unsaturated fatty acid compounds and compositions.

In some embodiments, chemically modified, maleated unsaturated fatty acid compositions include imidazoline modified maleated unsaturated fatty acid compounds and compositions.

In some embodiments, chemically modified, maleated unsaturated fatty acid compositions include metal chelator modified maleated unsaturated fatty acid compounds and compositions, including compounds and compositions modified with crown ethers, clathrates, phenolics, calixarenes, and cyclodextrin.

In some embodiments, chemically modified, maleated unsaturated fatty acid compounds and compositions include ester modified maleated unsaturated fatty acid compounds and compositions.

In some embodiments, chemically modified, maleated unsaturated fatty acid compounds and compositions include acetylenic alcohol modified maleated unsaturated fatty acid compounds and compositions.

In some embodiments, chemically modified, maleated unsaturated fatty acid compounds and compositions include morpholine modified maleated unsaturated fatty acid compounds and compositions.

In some embodiments, chemically modified, maleated unsaturated fatty acid compositions include phosphate ester modified maleated unsaturated fatty acid compounds and compositions.

In some embodiments, chemically modified, maleated unsaturated fatty acid compounds and compositions include amino acid modified maleated unsaturated fatty acid compounds and compositions, including lysine, polylysine, glycine, and cysteine.

In some embodiments, chemically modified, maleated unsaturated fatty acid compounds and compositions include xanthate modified maleated unsaturated fatty acid compositions.

In some embodiments, chemically modified, maleated unsaturated fatty acid compounds and compositions include thiophosphate ester modified maleated unsaturated fatty acid compounds and compositions.

In some embodiments, chemically modified, maleated unsaturated fatty acid compounds and compositions include hydroxamic acid modified maleated unsaturated fatty acid compounds and compositions.

In some embodiments, chemically modified, maleated unsaturated fatty acid compounds and compositions include sulfonate modified maleated unsaturated fatty acid compounds and compositions.

In some embodiments, chemically modified, maleated unsaturated fatty acid compounds and compositions include sulfate modified maleated unsaturated fatty acid compounds and compositions.

Further provided herein are methods of chemically modifying maleated unsaturated fatty acid compounds and compositions, for example, chemically modifying maleated tall oil compounds and compositions.

A variety of approaches for chemically modifying maleated unsaturated fatty acid compounds and compositions are provided. Although the examples and descriptions herein emphasize methods of making compositions, the chemistry is equally applicable to methods of making compounds. As will be appreciated by those skilled in the art from the representative molecules produced by such chemical modifications (as hereinafter illustrated), the chemically modified, maleated unsaturated fatty acid compositions can have a higher carboxylic functionality than industry standard dimmer/trimer acids, yet may be produced at a similar molecular weight. Without being bound by theory, this higher carboxylic functionality may enhance the suitability of some embodiments of such compositions for use as flotation collectors, formation of salt or soap (relevant to their use as emulsification aides), and also may give certain embodiments of the compositions a stronger film persistency on metal surfaces (relevant for corrosion inhibition applications, for example).

Ricinoleic Acid Modification

In a first approach, a maleated unsaturated fatty acid compound or composition, such as TOFA, is chemically modified with ricinoleic acid. Ricinoleic acid is the principal fatty acid constituent in castor oil. Castor oil is a vegetable oil obtained from the castor bean. Castor oil also contains a minor amount of both oleic and linoleic acids (generally less than 5%). Ricinoleic acid is also an 18-carbon fatty acid, but it also has a hydroxyl functional group at the twelfth carbon atom, see following formula:

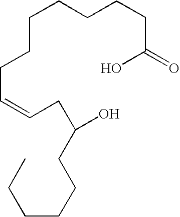

Because of its hydroxyl group, ricinoleic acid can be used to esterify a free carboxyl group on a maleated fatty acid, especially a maleated TOFA and most preferably a maleic anhydride maleated TOFA. Depending on the starting maleated fatty acid used, e.g., maleated TOFA, the relative mole ratios of the starting maleated fatty acid and the ricinoleic acid and the reaction conditions, one or more of the free carboxyl groups may be esterified.

For example, conducting the reaction at about a 1:1 mole ratio of rincinoleic acid to a maleic anhydride maleated TOFA under the preferred lower temperature reaction conditions identified below, one would anticipate producing the following representative molecular species using the maleated TOFA starting material:

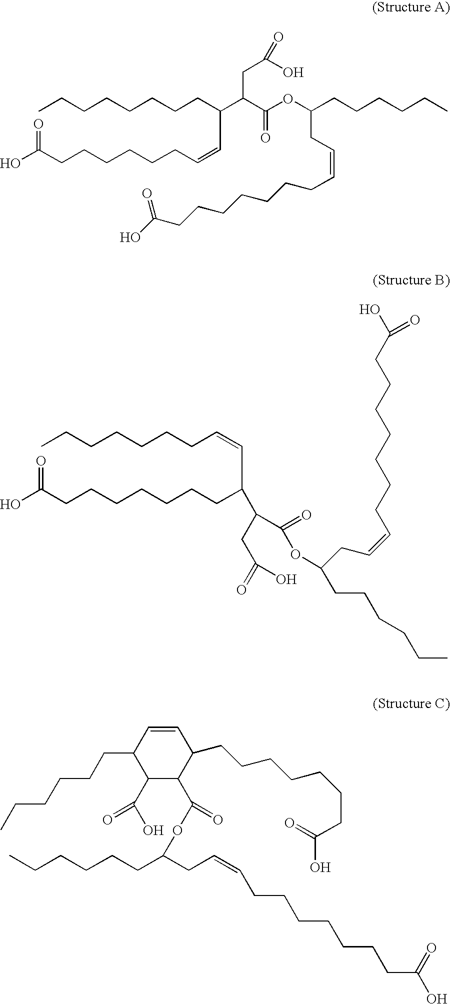

In one embodiment, the esterification of the maleated fatty acid with ricinoleic acid is conducted under conditions that favor reactions between the hydroxyl group of the ricinoleic acid and the carboxylic groups added to the fatty acid by the maleation reaction, in preference to any reactions between the hydroxyl group and any terminal carboxylic groups of the fatty acid. Such preferential reactions are possible because of the higher reactivity of the carboxyl groups added to the fatty acid by the maleation reaction relative to the terminal carboxylic groups of the fatty acids.

For example, the esterification of the maleated fatty acid with ricinoleic acid may proceed at a temperature above about 90° C. and up to a temperature of about 220° C., and an esterification catalyst can optionally be added to the reaction mixture to promote the esterification reaction. Suitable esterification catalysts are well known in the art. A non-exhaustive list of potential catalysts include inorganic acids, such as sulfuric acid, lead acetate, sodium acetate, calcium acetate, zinc acetate, organotin compounds, titanium esters, antimony trioxide, germanium salts, ammonium chloride, sodium hypophosphite, sodium phosphite and organic acids such as methanesulfonic acid and para-toluenesulfonic acid.

Preferably, the ricinoleic acid esterification reaction is conducted with a maleic anhydride maleated fatty acid, especially a maleic anhydride maleated TOFA containing composition in the absence of a catalyst and with the temperature limited to a temperature between about 90° C. and about 190° C. in order to more effectively selectively promote a reaction between the hydroxyl group of the ricinoleic acid and a carboxyl moiety that has been added onto the fatty acid via the maleation of the fatty acid (as shown in the idealized structures above).

Such esterification products have a certain similarity to the chemical structure of dimer/trimer acids currently produced from TOFA and soybean fatty acids and thus would be suitable for the same utilities, e.g., as a corrosion inhibitor component in oil field applications. The ricinoleic acid-modified maleated TOFA thus would provide a suitable alternative when faced with a shortage of such dimer/trimer acid products for existing requirements and uses.

Polyamine Modification

In an alternative embodiment, a maleated fatty acid, such as a maleated TOFA containing composition and preferably a maleic anhydride maleated fatty acid and particularly a maleic anhydride maleated TOFA containing composition, can be chemically modified with a polyamine, preferably a polyamine having two or more primary amine groups (i.e., a poly-primary amine). Suitable polyamines include diethylenetriamine, triethylenetetramine, tetraethylenepentamine, isophorone diamine, aminoethyl piperazine, lysine, polylysine and the like. Polyethyleneamines such as Amine HH commercially available from the Dow Chemical Co. also can be used. While the use of a primary amine is not an absolute requirement, it is preferred to use a poly-primary amine to allow for further derivatization of the resulting composition.

Also suitable for producing high molecular weight adducts with a maleated fatty acid are the Jeffamine® polyether amines. The Jeffamine® polyether amines contain primary amino groups attached to the terminus of a polyether backbone. The polyether backbone is based either on propylene oxide (PO), ethylene oxide (EO), or mixed EO/PO. Newer Jeffamine® products may contain other backbone segments and varied reactivity provided by hindering the primary amine or through secondary amine functionality. Low molecular weight Jeffamines (e.g. JEFFAMINE® D-230) are acceptable, as well as higher molecular weight Jeffamines (e.g. JEFFAMINE® D-2000). Another suitable molecular weight Jeffamine polyether amine is a medium molecular weight (e.g. JEFFAMINE® D-400) in order to obtain a desirable viscosity and high temperature stability in the chemically modified maleated fatty acid product.

In accordance with this aspect of the present invention, (1) the temperature at which the polyamine and maleated fatty acid reaction is conducted and (2) the relative mole ratio (or more appropriately the equivalent ratio of amine active hydrogens to carboxyl groups) established between the polyamine and the maleated fatty acid composition are appropriately set to promote the preparation of the desired amidated maleated fatty acid composition. In contrast to the prior art, the amine is not simply added to neutralize the fatty acid (done at substantially ambient conditions). Instead, reaction conditions are established (heat is applied) to promote the formation of a covalent amide bond between the fatty acid and the polyamine.

In particular, the amidation reaction is conducted (A) at a temperature which is sufficient to cause reaction between primary (and/or secondary) amine groups of the polyamine and a carboxyl moiety added onto the fatty acid by the previous maleation reaction(s) (typically at a temperature above about 50° C.), but (B) at a temperature which is no greater than about 200° C., usually no greater than about 190° C., and most often no greater than about 160° C. In one embodiment, the maleated fatty acid is a maleic anhydride maleated TOFA containing composition. A temperature in the range of 50° C. to about 90° C. should usually be acceptable for the amidation reaction using a polyamine. Such temperature is particularly appropriate when the source of the maleated fatty acid is a maleic anhydride maleated TOFA containing composition.

The purpose of controlling the reaction temperature and using a maleic anhydride maleated fatty acid, and especially a maleic anhydride maleated TOFA containing composition in this way, is to promote a selective reaction between the active hydrogens of the polyamine and a carboxyl moiety that has been added onto the fatty acid via the maleation of the fatty acid, but to avoid what may be considered indiscriminate reaction between the active hydrogens of the polyamine and fatty acid carboxyls.

By conducting the reaction in this manner, one is able to control the chemistry of the resulting reaction products so that the composition is populated with molecular species that have a molecular weight at least twice that of the original fatty acid with numerous free carboxyl groups and (depending on the polyamine being used) possibly numerous secondary amine groups as well. The key focus of the present invention, however, is to retain a large population of free carboxyl groups in the resulting composition. Indeed, even in the presence of a large number of residual secondary amines, the amidated maleated fatty acid will be characterized by an acid number for the composition usually above about 50 and often above about 100. Because of the participation of the free carboxyls in neutralizing residual amine groups, such products will often exhibit a total amine number of zero (0).

In addition, the amidation reaction usually is conducted with an excess of carboxyl groups in the maleated fatty acid composition relative to the total number of primary and secondary amines of the polyamine. The modification is generally practiced by establishing a mole ratio between the maleated fatty acid composition and the polyamine such that there is at least an equal amount of non-fatty acid carboxyl moieties relative to the total number of primary and secondary amine moieties. As used throughout the specification and in the claims, the phrase non-fatty acid carboxyl moieties is intended to refer to the carboxyl moieties added by the maleation of the fatty acid and to exclude the carboxyl group that is part of the original fatty acid molecule. Indeed, there is a preference to establish a mole ratio between the maleated fatty acid composition and the polyamine such that there is at least about a 1.5-fold and up to about a 6-fold excess of non-fatty acid carboxyl moieties relative to total number of primary and secondary amines of the polyamine. However, under appropriate circumstances, conducting the reaction under conditions where there is a relatively small excess of total primary and secondary amine groups relative to non-fatty acid carboxyl moieties in the composition can nonetheless produce suitable compositions. This is illustrated, for example, in Example 6.

As noted earlier, in a one embodiment of this invention, the polyamine reaction is conducted with a maleic anhydride maleated fatty acid and especially a maleic anhydride maleated TOFA containing composition. Furthermore, the reaction is usually conducted under conditions that favor the selective amidation of the maleate group with primary amines. In this circumstance, it is usual to establish a mole ratio between the maleic anhydride maleated fatty acid composition and the polyamine such that there is at least about a 2-fold excess and up to about 6-fold excess of non-fatty acid carboxyl moieties relative to total number of primary amine groups of the polyamine. As shown in Example 8, however, one needs to be judicious when operating with only a small excess of non-fatty acid carboxyl moieties in the absence of a significant amount of diluent non-maleated fatty acid material, or an undesired level of cross-linking and rapid viscosity build-up may occur.

Usually, the relative proportion of the maleated fatty acid reactant and the polyamine is selected such that the reaction product has a sufficient number of free carboxyls to neutralize any residual amine groups in the composition. In this case, the resulting composition has an amine number of zero. Even so, useful products have been prepared having an amine number greater than zero. If desired, a known amidification catalyst may be used to encourage reaction of all of the primary and secondary amines with carboxyl groups.

In another embodiment, the mole ratio of the polyamine to the maleic anhydride maleated fatty acid is proportioned such that on average a single polyamine molecule reacts with and opens the maleated moieties on at least two separate fatty acid molecules. Using diethylenetriamine (a di-primary amine), for example, to modify a maleic anhydride maleated TOFA containing composition, one would provide the polyamine to the maleated TOFA in about a 1:2 (di-primary amine:maleated TOFA) mole ratio or lower, i.e., an excess of maleated fatty acid. In this way, the poly-primary amine essentially (i.e., on average) “cross links” two fatty acid molecules together helping to build molecular weight, but not leading to an excessive viscosity increase. Thus, the resulting composition has a majority of its molecules comprising at least two maleated fatty acid molecular units linked together through a polyamine (e.g., a poly-primary amine). A representative molecular structure of a species in the poly-primary amine (diethylenetriamine) modified maleic anhydride maleated TOFA would be:

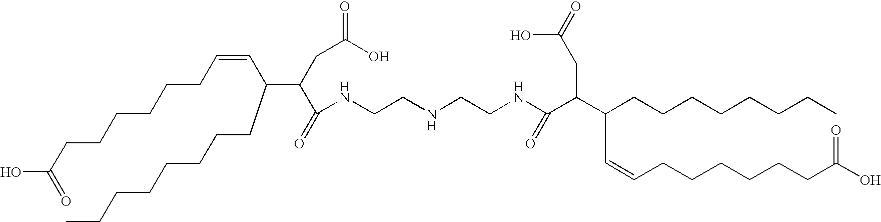

As shown, the composition resulting from the reaction between a maleated fatty acid (e.g., maleic anhydride maleated TOFA) and a poly-primary amine under conditions established in accordance with the present invention has both secondary amine and amide moieties, as well as residual carboxyl groups that are available for further reaction. Given the excess free carboxyls available for neutralizing the secondary amines, such products would usually have an amine number of essentially 0. Free carboxyls, in particular, also are available for salt formation by reaction with other basic materials, for further amidation, for esterification and for other reactions involving carboxyl functionality. These compositions provide a unique opportunity in developing products, for example, useful in formulating corrosion inhibitors, as emulsifiers, as cross-linking agents and as collectors in mining applications.

As was the case with the ricinoleic acid-modified maleated fatty acids, and particularly the ricinoleic acid-modified maleated TOFA containing compositions, these poly-primary amine modified maleated fatty acids are expected to be suitable for the same utilities as conventional dimer/trimer acids, e.g., as corrosion inhibitors in oil field applications. Such poly-primary amine modified maleated fatty acids thus would provide a suitable alternative when faced with a shortage of such dimer/trimer acid products for existing requirements.

Amino Alcohol Modification

Another class of chemical modifiers that function in a similar fashion to the polyamines for modifying maleated fatty acids in accordance with the present invention is amino alcohols, usually primary amine-containing amino alcohols, such as monoethanolamine, aminoethylethanolamine, diethanolamine, monoisopropanolamine, diisopropanolamine and the like. As above, the temperature at which the modification reaction(s) is(are) conducted and the mole ratio of the amino alcohol to the maleated fatty acid are influential in determining the nature of the modified maleated fatty acid product. Usually, an amidation reaction is conducted (A) at a temperature which is sufficient to cause reaction between primary (and/or secondary) amine groups of the amino alcohol and a non-fatty acid carboxyl moiety (typically a temperature above about 50° C.), but (B) at a temperature which is no greater than about 200° C., usually no greater than about 190° C., and most often no greater than about 160° C. A temperature in the range of 50° C. to about 90° C. should usually be acceptable for the amidation reaction. This range of reaction temperature is useful when the source of the maleated fatty acid is a maleic anhydride maleated TOFA containing composition.

As noted above, the purpose of controlling the reaction temperature and using a maleic anhydride maleated fatty acid, and especially a maleic anhydride maleated TOFA containing composition in this way, is to promote a selective reaction between the amine group of the amino alcohol and a carboxyl moiety that has been added onto the fatty acid via the maleation of the fatty acid (non-fatty acid carboxyl), but to avoid what may be considered indiscriminate reaction between the active hydrogens of the amino alcohol and fatty acid carboxyls.

Following the initial amidation reaction, the temperature can be increased to a temperature above about 90° C. and up to about 220° C., and an esterification catalyst can optionally be added to the reaction mixture to promote reaction between a hydroxyl group of the amino alcohol and another carboxyl group that has been added onto the fatty acid via the maleation of the fatty acid (i.e., a non-fatty acid carboxyl). Suitable esterification catalysts are well known in the art. A non-exhaustive list of potential catalysts include inorganic acids, such as sulfuric acid, lead acetate, sodium acetate, calcium acetate, zinc acetate, organotin compounds, titanium esters, antimony trioxide, germanium salts, ammonium chloride, sodium hypophosphite, sodium phosphite and organic acids such as methanesulfonic acid and para-toluenesulfonic acid.

As was the case with the polyamine modification, by conducting the initial amidation reaction in this manner, one is able to control the chemistry of the resulting reaction products so that the composition is populated with molecular species that have a molecular weight at least twice that of the original fatty acid with numerous free carboxyl groups. Indeed, a key focus of the present invention is to retain a large population of free carboxyl groups in the resulting composition. The so-modified maleated fatty acid will be characterized by an acid number for the composition usually above about 50 and often above about 100.

In addition, the amino alcohol modification reaction is conducted with an excess of carboxyl groups in the maleated fatty acid composition relative to the total number of primary amines and hydroxyl groups of the amino alcohol. The synthesis is generally practiced to establish a mole ratio between the maleated fatty acid composition and the amino alcohol such that there is at least an equal amount of non-fatty acid carboxyl moieties relative to the total number of primary amines and hydroxyl groups. Indeed, there is a preference to establish a mole ratio between the maleated fatty acid composition and the amino alcohol such that there is at least about a 1.5-fold excess and up to about a 6-fold excess of non-fatty acid carboxyl moieties relative to total number of primary amines and hydroxyl groups. However, under appropriate circumstances, conducting the reaction under conditions where there is a relatively small excess of total primary amine and hydroxyl groups relative to non-fatty acid carboxyl moieties in the composition can nonetheless produce suitable compositions.

As noted earlier, in another embodiment of this invention, the amino alcohol reactions are conducted with a maleic anhydride maleated fatty acid composition and especially a maleic anhydride maleated TOFA containing composition. Furthermore, it is typical to conduct the reactions under conditions that favor the selective amidation and esterification of the maleate moieties (maleate carboxyls) with the primary amines and hydroxyl groups. In this circumstance, it is normal to establish a mole ratio between the maleic anhydride maleated fatty acid composition and the amino alcohol such that there is at least about a 2-fold excess and up to about a 6-fold excess of non-fatty acid carboxyl moieties relative to total number of primary amine and hydroxyl groups of the amino alcohol.

As above, it is usual to proportion the amino alcohol and the maleated fatty acid composition such that on average a single amino alcohol molecule, such as a preferred primary amine-containing amino alcohol, reacts with and thus opens the maleated moieties (by separate amidation and esterification reactions) on at least two separate fatty acid molecules. Using aminoethylethanolamine, for example, to modify a maleic anhydride maleated TOFA containing composition, one would provide the aminoethylethanolamine to the maleated TOFA in about a 1:2 (primary amine-containing amino alcohol:maleated TOFA) mole ratio or lower, i.e., an excess of maleated fatty acid. In this way the amino alcohol, and typically the primary amine-containing amino alcohol essentially (i.e., on average) “cross links” two fatty acid molecules together helping to build molecular weight. Thus, the resulting composition has a majority of its molecules comprising at least two maleated fatty acid molecular units linked together through an amino alcohol. A representative molecular structure of a species in the primary amine-containing amino alcohol (aminoethylethanolamine)-modified maleated TOFA adduct would be:

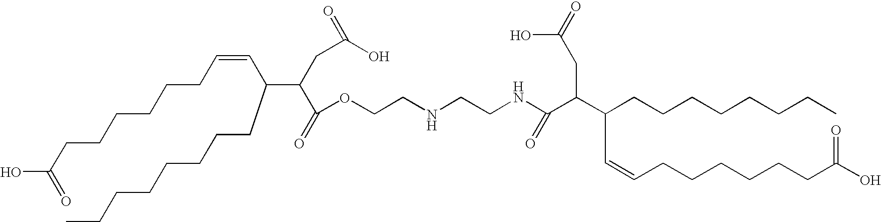

As shown, the composition resulting from the reaction between a maleated fatty acid molecule (e.g., maleic anhydride maleated TOFA) and the primary amine-containing amino alcohol (aminoethylethanolamine) has ester, secondary amine and amide moieties, as well as residual carboxyl groups that are available for further reactions. Given the excess free carboxyls available for neutralizing any secondary amines, such products usually would have an amine number of essentially 0. The free carboxyls, in particular, are available for salt formation by reaction with other basic materials, for further amidation, for esterification and for other reactions involving carboxyl functionality.

As was the case with the ricinoleic acid-modified maleated fatty acid compositions, and particularly the ricinoleic acid-modified maleated TOFA containing compositions, these amino alcohol modified maleated fatty acids are expected to be suitable for the same utilities as conventional dimer/trimer acids, e.g., as a component of corrosion inhibitors in oil field applications. Such amino alcohol modified maleated fatty acids thus would provide a suitable alternative when faced with a shortage of such dimer/trimer acid products for existing requirements.

Imidazoline Modification

Known fatty imidazolines useful as corrosion inhibitors are prepared by reacting tall oil fatty acid (TOFA) with diethylenetriamine at about a 1:1 mole ratio. Typical products have an acid value of about 6-10 and an amine number of 250-300. The present invention contemplates the use of such fatty imidazolines to chemically modify (via an amidation reaction) a maleated fatty acid composition and particularly a maleic anhydride maleated TOFA containing composition. While the prior art has used such fatty imidazolines in combination with maleated fatty acids under conditions where a neutralization reaction would likely have occurred between free amine and carboxyl moieties of the respective species, the prior art has not suggested the amidation of a maleated fatty acid with a fatty imidazoline.

The idealized reactants and amidation product are shown by the following representative equations showing fatty imidazoline formation and the subsequent amidation reaction with a maleic anhydride maleated fatty acid:

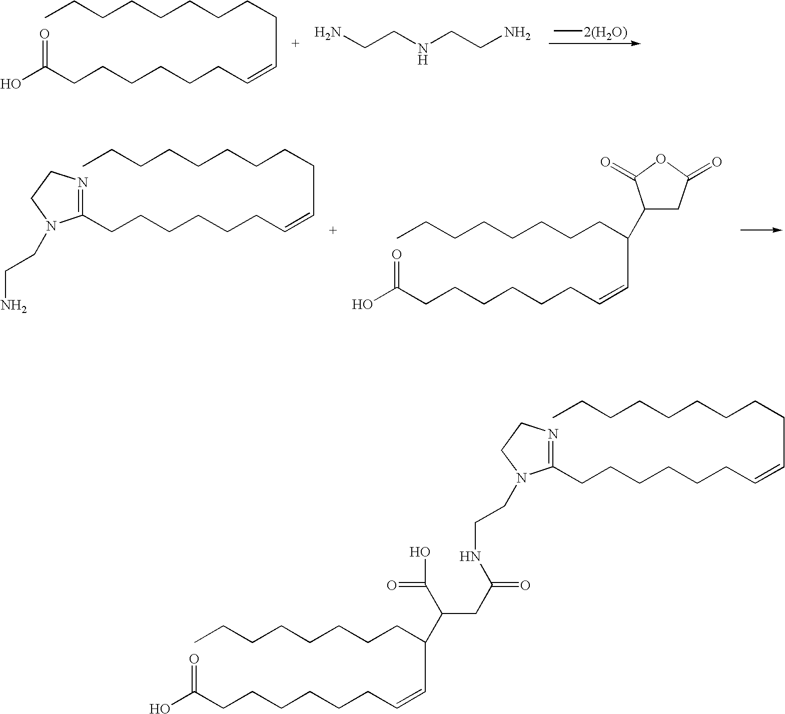

As with the use of polyamines and amino alcohols to modify maleated fatty acids via an amidation reaction, when using fatty imidazolines it is equally important to conduct the reaction between the primary amine of the imidazoline and the maleated fatty acid composition at a temperature which is sufficient to cause reaction between the primary amine group of the fatty imidazoline and a carboxyl group added onto the fatty acid by the previous maleation reaction(s), i.e., a non-fatty acid carboxyl moiety.

In particular, the amidation reaction is conducted (A) at a temperature which is sufficient to cause reaction between the primary amine group of the fatty imidazoline and a carboxyl moiety added onto the fatty acid by the previous maleation reaction(s) (typically at a temperature above about 50° C.), but (B) at a temperature which is no greater than about 200° C., usually no greater than about 190° C., and most often no greater than about 160° C. In one embodiment, the maleated fatty acid is a maleic anhydride maleated TOFA containing composition. A temperature in the range of 50° C. to about 90° C. should usually be acceptable for the amidation reaction. This temperature range should be suitable when the source of the maleated fatty acid is a maleic anhydride maleated TOFA containing composition. Again, the purpose of controlling the reaction temperature in this way is to promote a reaction between the primary amine of the fatty imidazoline and a carboxyl group that has been added onto the fatty acid via the maleation of the fatty acid (a non-fatty acid carboxyl moiety) to yield molecular species shown immediately above.

The fatty imidazoline also should be proportioned with respect to the maleated fatty acid composition such that on average each imidazoline reacts with and where necessary opens the maleated moieties on a single maleated fatty acid molecule (i.e., about a 1:1 mole ratio of fatty imidazoline to maleated fatty acid). With this chemistry, a reaction product is produced that (i.e., on average) effectively “cross links” two fatty acid molecules (one supplied by the fatty imidazoline and one supplied by the maleated fatty acid) together helping to build molecular weight. Thus, the resulting composition has a majority of its molecules comprising at least two fatty acid molecular units linked together while retaining free carboxyls, and secondary and tertiary amine functional groups. Such molecules are oil soluble and will provide corrosion inhibitory activity to a variety of oil well-related applications including for invert emulsion-type drilling fluids and in the transport and processing of hydrocarbon streams.

As was the case with the ricinoleic acid-modified maleated fatty acid compositions, and particularly the ricinoleic acid-modified maleated TOFA, these fatty imidazoline modified maleated fatty acids are expected to be suitable for the same utilities as conventional dimer/trimer acids, e.g., as corrosion inhibitors in oil field applications. Such imidazoline modified maleated fatty acids thus would provide yet another alternative when faced with a shortage of such dimer/trimer acid products for existing requirements.

Metal Chelate Modification

Also provided herein are chemically modified, maleated unsaturated fatty acid compounds and compositions modified with metal chelators. A metal chelator can be chosen from any cyclic and acyclic organic chelating agent such as diethylene triamine pentaacetic acid (DTPA), 1,4,7,10-tetraazacyclododecane-1,4,7,10-tetraacetic acid (DOTA), 1,4,7-tris(carboxymethyl)-1,0-(2′-hydroxypropyl)-1,4,7,10-tetraazacyclododecane (HP-DO3A), DOTAGA, 1,4,7-triazacyclonon-one-1,4,7,-triyltriacetic acid (NOTA), Glu-DTPA, DTPA-BMA, ethylenediaminetetraacetic acid (EDTA), polyacrylic acid, polymaleic acid, polycitacenic acid, polyaspartic acid, aspartic acid, crown ethers, clathrates, phenolics, calixarenes, citric acid, and cyclodextrin. In some embodiments, a metal chelator (chemically) modified, maleated unsaturated fatty acid compound or composition can be prepared by providing an amine (chemically) modified maleated unsaturated fatty acid compound or composition and exhaustively reacting the amine (chemically) modified maleated unsaturated fatty acid compound or composition with chloroacetic acid. Coordination of such species to the carboxyl moieties of the chemically modified, maleated unsaturated fatty acid compounds or compositions are known in the art. In some embodiments, condensation of the maleated unsaturated fatty acid compound or composition with a polyamine or a polyol prior to coordination with a metal chelator can facilitate linking of the metal chelator to the maleated unsaturated fatty acid compound or composition. Some embodiments of such modified compositions may be useful in various flotation applications as collectors.

Ester Modification

Provided herein are chemically modified, maleated unsaturated fatty acid compounds and compositions having an ester modification. An ester modified maleated unsaturated fatty acid composition can be prepared by reacting an alcohol with a maleated unsaturated fatty acid composition. In some embodiments, the alcohol is one that is biodegradable, such as an unbranched C5-15 alcohol (e.g., a C5-15 alcohol). In other embodiments, an ester-modified maleated unsaturated fatty acid compound or composition is prepared by reaction of a maleated unsaturated fatty acid composition with glycerin, partially saponified natural oils, natural oils that are partially transesterified with other alcohols, ethylene glycol, propylene glycol, polyethylene glycols, polypropylene glycols, sugars, 1,3-propanediol, pentaerythritol, trimethylol propane. In certain embodiments, such compositions may be used in further derivatizing reactions. In other embodiments, certain ester-modified maleated unsaturated fatty acid compositions may be used as corrosion inhibitors.

Amino Acid Modification

Also provided herein are amino acid modified maleated unsaturated fatty acid compounds and compositions. In one embodiment, an amino acid modified maleated unsaturated fatty acid composition can be prepared through the reaction of a sarcosine with a maleated unsaturated fatty acid composition. Sarcosines are the condensation product of a fatty acid and the amino acid glycine. In one embodiment, a polysarcosine modified maleated unsaturated fatty acid composition can be made by condensing a maleated unsaturated fatty acid compound or composition with glycine. In another embodiment, polysarcosine modified maleated unsaturated fatty acid composition can be made by first condensing an unsaturated fatty acid composition with glycine then maleating the modified composition. In some embodiments, further sarcosine functionality can be added by condensing the newly formed carboxylic functionality from the maleation reaction with more glycine. Similar modifications can be made by modifying the maleated unsaturated fatty acid compounds or compositions with any natural or unnatural amino acid, for example, tyrosine, lysine, ornithine, arginine, glutamine, glutamic acid, aspartic acid, tryptophane, asparagine, cysteine, cystine, dibromotyrosine, histidine, dydroxylysine, hydroxyproline, isoleucine, leucine, methionine, phenylalanine, alanine, praline, serine, threonine, thyroxine, valine, gamma-aminobutyric acid (GABA), aminobenzoic acid, anthranilic acid, chloroanthranilic acid, amino adipic acid, aminohexanoic acid, aminocaprylic acid, and the like. In other embodiments, the amino acid is lysine, polylysine, ornithine, arginine, aspartic acid, or cysteine. Suitable amino acids thus would also include biogenic amino acids such as alanine, aminobutyric acid, arginine, asparagine, aspartic acid, cysteine, cystine, dibromotyrosine, diidotyrosine, glutamic acid, glutamine, histidine, homocysteine, hydroxylysine, hydroxyproline, isoleucine, leucine, lysine, methionine, ornithine, phenylalanine, proline, sarcosine, serine, threonine, thyroxine, tryptophane, tyrosine, and valine, and all potential dimers, oligomers and polymers made from such amino acids. Synthetic amino acids including aminobenzoic acid, aminosalicylic acid, aminoundecanoic acid and all potential dimers, oligomers and polymers made from them are likewise suitable raw materials.

Using biogenic sourced amino acids one potentially has a more environmentally friendly and renewable product. The side chains of the amino acid also provide the opportunity for further functionalization.

These compounds can be used as emulsifiers particularly in oil field applications and as flotation collectors. In some embodiments, these materials may be useful specifically as fluorspar collectors.

Polyfunctional Corrosion Inhibitors

The present invention also provides new polyfunctional corrosion inhibitors by chemically integrating certain known corrosion inhibitors with maleated fatty acids using the esterification and/or amidation reactions as previously described.

For example, in the case of corrosion inhibitors such as propargyl alcohol and morpholine, one can use the above described esterification and amidation reactions, respectively, to introduce these functional corrosion inhibitors onto the maleated fatty acid scaffold producing enhanced corrosion inhibitors.

In particular, by esterifying a maleated fatty acid, and especially a maleic anhydride maleated TOFA containing composition with an alkynyl alcohol such as propargyl alcohol one adds a triple bond as a separate moiety on the maleated fatty acid. This not only creates additional opportunity for further chemical modification of the composition but itself creates a new and useful additive for formulating corrosion inhibitors. Propargyl alcohol is a known corrosion inhibitor; accordingly, the ester formed by reacting propargyl alcohol and a maleated fatty acid composition (e.g., a maleic anhydride maleated TOFA) is also expected to be particularly useful for corrosion inhibition applications. Other materials that can be used in a similar fashion to propargyl alcohol include 1-hexyn-3-ol and 5-decyne-4,7-diol and the oxyalkylated adducts of these acetylenic alcohols, see U.S. Pat. No. 3,931,336 and EPA 0 239 770.

In the case of using morpholine, one uses the amidation reaction that occurs between the secondary amine of morpholine and a carboxyl moiety of a maleated fatty acid, and preferably a non-fatty acid carboxyl moiety of a maleated fatty acid composition (preferably of a maleic anhydride maleated TOFA containing composition), to produce the modified maleated fatty acid composition. This morpholine-modified maleated fatty acid also is expected to be useful in formulating corrosion inhibitory compositions.

Yet one more class of known corrosion materials suitable for chemically modifying the maleated fatty acids and especially maleic anhydride maleated TOFA containing compositions is the phosphate esters. In particular, one class of known phosphate esters is prepared by reacting an ethoxylated alcohol with polyphosphoric acid, or with phosphoric anhydride. Generally, the alcohol is one that is biodegradable and can be made water-soluble by ethoxylation, such as an unbranched C₅₋₁₅ alcohol, especially C₅₋₁₂ alcohols. These materials have a residual hydroxyl group that can be used to chemically integrate the phosphate ester corrosion inhibitors with the maleated fatty acids using the esterification reaction. A representative molecular structure of a species in the phosphate ester modified maleated TOFA containing composition would be:

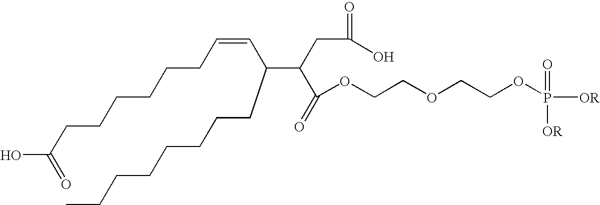

Where R can be selected from H, C₁-C₁₈ alkyls and C₂-C₁₈ alkenyls.

In a further embodiment, maleated unsaturated fatty acid compositions may be modified with xanthates. Xanthates are prepared by the reaction of carbon disulfide with an alcohol-modified maleated unsaturated fatty acid compound or composition. The alcohol-modified maleated unsaturated fatty acid compound or composition can be made by esterifying the maleated unsaturated fatty acid compound or composition with a diol or a polyol, for example, pentaerythritol, ethylene glycol, glycerol, polyethylene glycol, propylene glycol, polypropylene glycol, other propanediols, butane diols, pentane diols, and hexane diols. In some embodiments, a polyxanthate flotation collector can be prepared by first condensing an unsaturated fatty acid composition with a diol or polyol followed by reaction with carbon disulfide. The reaction product can then be maleated to produce a chemically modified, maleated unsaturated fatty acid compound or composition.

In another embodiment, further xanthate functionality can be added by condensing the non-fatty acid carboxyl moieties with additional diol or polyl followed by carbon disulfide reaction. In some embodiments, fatty unsaturated alcohols or maleated unsaturated fatty acid compositions can be used in place of the esterified fatty acids or compositions as described above. In any case, some embodiments of the resulting polyxanthate collectors may be ideal for copper, platinum, and gold flotation. Similar products called thionocarbamates can be prepared with fatty unsaturated amines or amido amines in place of the esterified fatty acids compositions. These collectors may be useful for mining of copper sulfide ores.

In another embodiment, the process detailed for the production of phosphate esters above can be used to prepare thiophosphate esters. In one example, by substituting phosphorus pentasulfide for phosphorus pentoxide, thiophosphate ester modified maleated unsaturated fatty acid compositions can be prepared. Such compositions may have use as co-collectors for sulfide minerals when used with xanthates.

Also provided herein are hydroxamic acid modified maleated unsaturated fatty acid compounds and compositions. Hydroxamic acids are the condensation products of fatty acids and hydroxylamines. In one embodiment, a polyhydroxamic acid modified maleated unsaturated fatty acid compound or composition can be prepared by condensing a maleated unsaturated fatty acid composition with hydroxylamine. In some embodiments, a polyhydroxamic modified maleated unsaturated fatty acid composition can be made by first condensing an unsaturated fatty acid composition with hydroxylamine followed by maleating the modified unsaturated fatty acid. Further hydroxamic acid functionality can be added by condensing the newly formed carboxylic functionality from the maleation reaction with additional hydroxylamine. Some of the embodiments of modified compositions prepared from hydroxamic acids may be useful as phosphate collectors and as collectors for anatase minerals in the reverse flotation of kaolin clay.

Sulfonate & Sulfate Modification

Sodium alkyl sulfates can be used in the flotation of barite when it is found together with fluorspar and calcite. They can also be used for the flotation of celestite, gypsum, kainite, anhydrite, and anglesite. For example, sodium dodecyl sulfate has been used as a uranium ore collector. In addition, sulfonates, like petroleum sulfonates, can be used to float anatase (titaniferrous) to separate it from fine kaolin clay.

Sulfonate modified maleated unsaturated fatty acid compositions can be synthesized by treatment of a maleated unsaturated fatty acid composition with a solution of sodium bisulfite or with fuming sulfuric acid. One example can be prepared by treating glycerol esters of a maleated unsaturated fatty acid composition with chlorosulfonic acid. Some embodiments of sulfonate or sulfate modified maleated unsaturated fatty acid compositions may be more efficient than traditional petroleum sulfonates and alkyl sulfates as flotation collectors, and they are derived from renewable resources like fatty acids instead of from petroleum.

General Considerations

For use in corrosion inhibition applications and especially for emulsification applications, applicants also contemplate that the chemically modified fatty acid products enumerated above, and especially the chemically modified maleated (such as modified using maleic anhydride) tall oil materials of the present invention can be combined with other materials, in order for example to neutralize one or more of the free carboxyl moities. For example, the chemically modified fatty acid products can be neutralized with various organic bases including amines, such as alkylene amines, e.g., diethylenetriamine, imidazoline, amidoamines, amidoamine condensates, and alkanolamines such as monoethanolamine, diethanolamine, triethanolamine and the like, and alternatively with a variety of inorganic bases to produce the related sodium, potassium and calcium salts of the chemically modified fatty acid products of the present invention as will be recognized by those skilled in the art.

When used in corrosion inhibition applications, in particular, the compositions of the present invention and the related salts thereof will normally be used in a concentration from about 5 ppm up to as much as 10% by weight, more usually in an amount between 20 ppm and 1% by weight.

When used as an emulsifier, generally the chemically modified maleated fatty acid compositions, such as the chemically modified maleated (particularly using maleic anhydride) tall oil materials and the related salts thereof, will be used in an amount of from about 2% to about 15% by weight of the emulsion. In such applications, hydrophobic materials can be emulsified with sufficient agitation in a hydrophilic vehicle such as water. Alternatively, hydrophilic materials could be emulsified with sufficient agitation in a hydrophobic vehicle, such as an oil. Particular applications for using the chemically modified, maleated unsaturated fatty acids and the salts thereof as an emulsification adjuvant include oil drilling muds, oil sands processing, asphalt, oil pipelines, mineral slurry pipelines and other processes requiring emulsification.

Also, the chemically modified maleated fatty acid compositions, such as the chemically modified maleated tall oil compositions of the present invention may be dissolved or dispersed in a carrier solvent to facilitate the coating of metals when used as a corrosion inhibiting composition. Suitable carrier solvents include, but are not limited to, the following: water, alcohols, kerosene, heavy aromatic naphtha, crude oil and combinations thereof.

In petroleum-recovery applications, where the chemically modified maleated fatty acids of the present invention are usefully employed, the downhole conditions in an oil or gas well can vary greatly from one well to the next. That is, in one environment one may encounter “sweet” conditions (predominately CO₂) while in another environment “sour” conditions may predominate (H₂S present). The chemically modified maleated fatty acids of the present invention can be used under both conditions.

As noted above, the chemically modified maleated fatty acid compositions, such as the chemically modified maleated (particularly using maleic anhydride) tall oil materials of the present invention are also expected to be useful in a variety of mining and other related applications.

For example, substances identified as “collectors” can be used to chemically and/or physically adsorb preferentially onto one of the substances in the suspension or dispersion (often, though not always the valued material in the suspension or dispersion, e.g., reverse flotation) to render it more hydrophobic and more amenable to flotation.

Thus, the chemically modified compositions of the present invention may be used in froth flotation (and reverse floatation) separation applications (e.g., in ore beneficiation) to enhance the separation of siliceous materials from other non-siliceous materials.

Flotation is practiced in the beneficiation of a wide variety of valued materials, including the recovery of minerals (e.g., phosphorous and potassium) and metal ores (e.g., platinum group elements), the recovery of high molecular weight hydrocarbons such as bitumen from sand and/or clay, and the separation of coal from its ash content to name a few, to obtain the removal of unwanted contaminants, which are unavoidably co-extracted from natural deposits, from the valued material.

In the case of solid ore beneficiation, the use of flotation generally comprises grinding the crude ore into sufficiently small, discrete particles and then contacting an aqueous “pulp” of this ground ore with rising air bubbles, typically while agitating the pulp. Prior to flotation, the crude ore may be subjected to any number of preconditioning steps, including selective crushing, screening, desliming, gravity concentration, electrical separation, low temperature roasting, and magnetic differentiation.

The chemically modified compositions of the present invention can function as a collector in such applications. Such applications would include the purification of kaolin clay, upgrading the energy value of mined coal, recovering mineral values (e.g., phosphate, potash, lime, sulfate, gypsum, iron, platinum, gold, palladium, titanium, molybdenum, copper, uranium, chromium, tungsten, manganese, magnesium, lead, zinc, silver, graphite, nickel, bauxite, borax, borate and the like) from clay impurities, the separation of bitumen from clay impurities and the like.

The chemically modified materials of the present invention may also have use in water purification applications where it is necessary to remove solid particulate contaminants (such as by flocculation) or heavy metal ion contaminants (such as by extraction) from water. In all such applications, it is expected that the chemically modified materials of the present invention will be added to the aqueous mixtures being treated in an amount of between about 0.005% to about 0.25% by weight.

Thus, in one embodiment the present invention relates to a process for obtaining a valued material from an aqueous suspension, dispersion or solution containing the valued material comprising adding to the aqueous suspension, dispersion or solution a chemically modified compound or composition of the present invention.

In still another embodiment, a chemically modified composition of the present invention could also be used for airborne dust suppression. In particular, a composition of a chemically modified maleated unsaturated fatty acid, such as an aqueous composition, would be applied onto a dust generating surface in order to reduce airborne dust formation. Such a composition could be used on roads, on open railcars and trucks carrying fugitive solids, on conveyer belts, for dirt parking lots, and other surfaces where airborne dust generation could present a problem. A composition of a chemically modified maleated unsaturated fatty acid also could be blended or co-reacted with certain additives to improve performance in such applications or to lower the overall cost of the composition. Such additives include crude tall oil, oxidized crude tall oil, fuel oil, kerosene, heavy oils and waxes, humic acid, tannins, lignosulfonates, polysaccharides, urea formaldehyde adducts, tall oil pitch, coal tar pitch, asphalt, fatty acids, oxidized unsaturated fatty acids, oxidized maleated unsaturated fatty acids, maleated unsaturated fatty acids, fatty acid dimers, vegetable oils, animal oils and fats.

In another embodiment, the composition of a chemically modified maleated unsaturated fatty acid can be added to a cementitious slurry in order to reduce its viscosity. Materials which when added to a cementitious slurry, such as a cement slurry or a gypsum slurry, to produce a higher flow at a lower water usage are known in the art alternatively as dispersing agents, superplasticizers, water reducing aids and the like. Functionally, these materials reduce the slurry's viscosity allowing it to flow more readily. The compositions of a chemically modified maleated unsaturated fatty acid described above exhibit this behavior. Thus, the present invention is also directed to a process for reducing the viscosity of a cementitious slurry comprising adding a composition of a chemically modified maleated unsaturated fatty acid to the slurry. Results may be obtained by adding the composition of a chemically modified maleated unsaturated fatty acid in an amount between about 0.0001 to 0.1 part by weight of the chemically modified maleated unsaturated fatty acid per part by weight of the total solids material in the slurry.

In another embodiment, the present invention is:

1. A composition comprising chemically modified, maleated unsaturated fatty acids and the salts thereof, wherein the chemical modification is selected from the group consisting of (1) esterification of the maleated unsaturated fatty acids with ricinoleic acid, (2) amidation of the maleated unsaturated fatty acids using a polyamine supplied in an amount to cause cross linking between maleated fatty acid molecules, (3) a combination of esterification and amidation of the maleated unsaturated fatty acids using an amino alcohol supplied in an amount to cause cross linking between maleated fatty acid molecules, (4) esterification of the maleated unsaturated fatty acids with an alkynyl alcohol selected from propargyl alcohol, 1-hexyn-3-ol, 5-decyne-4,7-diol, oxyalkylated propargyl alcohol and mixtures thereof, (5) amidation of the maleated unsaturated fatty acids with morpholine, (6) amidation of the maleated unsaturated fatty acids with a fatty imidazoline, (7) esterification of the maleated unsaturated fatty acids with a phosphate ester, (8) metal chelator modification, (9) reaction of the maleated unsaturated fatty acids with an amino acid, (10) xanthate modification, (11) thiophosphate ester modification, (12) hydroxamic acid modification, (13) sulfonate modification, (14) sulfate modification and combinations thereof.
2. The composition of paragraph 1 wherein the chemically modified, maleated unsaturated fatty acid has an acid number of at least 50 mg KOH/g before neutralization.
3. The composition of any preceding paragraph wherein the chemically modified, maleated unsaturated fatty acid has an average molecular weight greater than about 820.
4. The composition of any preceding paragraph wherein the chemically modified, maleated unsaturated fatty acid before neutralization has an acid value between 50 mg KOH/g and 300 mg KOH/g.
5. The composition of any preceding paragraph wherein the maleated unsaturated fatty acid is amidated using a polyamine at a temperature between 50° C. and about 200° C.
6. The composition of any preceding paragraph wherein the unsaturated fatty acids comprise unsaturated C₁₈ fatty acids.
7. The composition of any preceding paragraph wherein the unsaturated fatty acids comprise a tall oil composition containing tall oil fatty acid.
8. The composition of any preceding paragraph wherein the unsaturated fatty acids comprise a tall oil composition containing a tall oil rosin acid.
9. The composition of any preceding paragraph wherein the maleated fatty acids have been maleated with maleic anhydride.
10. The composition of any preceding paragraph wherein the maleated fatty acids have been maleated with from about 2% to about 25% by weight of maleic anhydride.
11. A method for reducing corrosion associated with a metal surface comprising contacting said surface with a corrosion inhibiting amount of the composition of any preceding paragraph.
12. A method for emulsifying a material comprising agitating the material in a suitable liquid in the presence of an emulsifying amount of the composition of the chemically modified, maleated unsaturated fatty acid or a salt thereof of any preceding paragraph.
13. A method for separating a valued material from an aqueous solution, suspension or dispersion containing the valued material comprising adding to the aqueous solution, suspension or dispersion an effective amount of the composition of any preceding paragraph.
14. A method for suppressing airborne dust comprising contacting a dust generating surface with an effective amount of the composition of any preceding paragraph.
15. A method for reducing the viscosity of a cementitious slurry comprising adding an effective amount of the composition of any preceding paragraph to the slurry.

It will be understood that while the invention has been described in conjunction with specific embodiments thereof, the foregoing description and examples are intended to illustrate, but not limit the scope of the invention. As shown hereinafter, the modified fatty acid products of this invention typically exhibit an acid number of between about 50 mg KOH/g and 300 mg KOH/g. Many of the products have an amine number of zero (0). Other aspects, advantages and modifications will be apparent to those skilled in the art to which the invention pertains, and these aspects and modifications are within the scope of the invention, which is limited only by the appended claims.

### EXAMPLE 1

### Maleation of Crude Tall Oil

A crude Tall Oil (95 wt. %) is charged to a sealed reactor fitted with an agitator, a thermocouple and a condenser. The reaction mixture is heated to 180° C. At 180° C., maleic anhydride (5 wt. %) is added slowly to the reactor. The reaction mixture is then heated to 200° C. for approximately 3-6 hours or until all of the maleic anhydride has reacted. Once all of the maleic anhydride has reacted, the reaction mixture is then cooled to 180° C. Representative properties of this maleated material, as compared to the original crude Tall Oil material, are presented in the following Table.

| | | Maleated Crude |
|---|---|---|
| | Crude Tall Oil | Tall Oil |
| Acid Value | 161.6 | 169.5 |
| Density (25° C.; Lbs/gal) | 8.088 | 8.54 |
| Specific. Gravity (25° C.) | 0.9706 | 1.003 |
| Brookfield Viscosity (cPs; 25° C.) | 695.0 | 33,800 |

### EXAMPLE 2

### Maleated Tall Oil Fatty Acid

TOFA is charged to a sealed reactor and the contents of the reactor are heated to 70° C. Once a temperature of 70° C. is achieved maleic anhydride in an amount of about 25% by weight of the TOFA is added to the vessel. After all maleic anhydride is in the reactor the reactor mixture is heated to 220° C. in several stages. From the starting temperature of 70° C.; the temperature is increased in small increments until 220° C. is achieved. After each temperature adjustment and the desired set point is reached, the material is maintained at the set point temperature for a five minute hold period. The first stage of heating is from 70° C. to 130° C.; the second stage of heating is from 130° C. to 160° C.; the third stage of heating is from 160° C. to 185° C.; the fourth stage of heating is from 185° C. to 205° C.; and the fifth and final stage of heating is from 205° C. to 220° C. The reaction mixture then is held at 220° C. until a Gardner-Holdt viscosity of about Z-2 is reached. This holding period typically takes about 5 hours depending on the batch size. The reaction mixture is cooled to a discharge temperature and one can then determine the physical properties of the maleated product. Typically, the maleated product exhibits an acid number of about 300-320 mg KOH/g, a specific gravity of 1.04 and a Brookfield Viscosity (at 25° C.) of about 2700-3400 cps.

### EXAMPLE 3

### Amidating Maleated Tall Oil Fatty Acid with DETA

To a suitable clean and dry reaction vessel, 95.7% by weight of a maleated TOFA (acid value about 340 mg KOH/g) made according to Example 2 is added. The contents of the reactor are heated with agitation and under a nitrogen atmosphere to about 110-115° C. Thereafter, 4.3% by weight of diethylenetriamine (DETA) is added to the reactor (establishing an amine to maleated TOFA mole ratio well below 1:2) and the contents of the reactor are allowed to exotherm to about 150° C. Once all of the DETA has been added, the reactor contents are heated to 180° C. and reacted at this temperature for a time sufficient to consume all of the primary amino moieties. A time of about 40 minutes should be sufficient in many cases. Typically, the amidated, maleated product should exhibit an acid number of about 187 mgKOH/g, an amine number of zero (0) and a Brookfield Viscosity (at 25° C.) of about 189,000 cps.

Techniques to measure acid and amine numbers are well known in the art and need not be described here. Amine number is determined by titrating the product with a standardized solution of HCl. Amine number can be determined using AOCS (American Oil Chemists Society) Test Method Tf 1a-64 (ASTM D 2074-92, or alternatively ASTM D 2074-93). The amine number is indicative of the amounts (in mgs) of free amine functionality per gram of sample.

### EXAMPLE 4

### Esterifying Maleated Tall Oil Fatty Acid with Ricinoleic Acid

To a suitable clean and dry reaction vessel, 56.6% by weight of a maleated TOFA made according to Example 2 is added. The contents of the reactor are heated with agitation and under a nitrogen atmosphere to 110° C. Thereafter, 43.4% by weight of ricinoleic acid is added to the reactor (establishing a ricinoleic acid to TOFA mole ratio of about 1:1) and the contents of the reactor are heated to 150° C. Once all of the ricinoleic acid has been added, the reactor contents are heated further to 180° C. and reacted at this temperature for a time sufficient to stabilize the acid number (i.e., to consume all of the hydroxyl moieties or the ricinoleic acid). Typically, the esterified, maleated product should exhibit an acid number (hydrous) of about 206 mg KOH/g, an amine number of zero (0) and a Brookfield Viscosity (at 25° C.) of about 72,600 cps.

### EXAMPLE 5

### Amidating Maleated Tall Oil Fatty Acid with DETA

To a suitable clean and dry reaction vessel, 95.3% by weight of a maleated TOFA made at a fatty acid to maleic anhydride mole ratio of 2:1.

The maleated TOFA should be prepared as follows. To a suitable clean and dry reaction vessel 85.9% by weight of TOFA is added. The contents of the reactor are heated with agitation and under a nitrogen atmosphere to 70° C. Thereafter, 14.1% by weight of maleic anhydride (MA) is added to the reactor (establishing a TOFA to MA mole ratio of 2:1) and the contents of the reactor are heated. From the starting temperature of about 70° C.; the temperature is incrementally increased until 220° C. is achieved. After each temperature adjustment and the desired set point is reached, the material is maintained at the set point temperature for a short hold period. The first stage of heating is from 70° C. to 130° C.; the second stage of heating is from 130° C. to 160° C.; the third stage of heating is from 160° C. to 180° C.; the fourth stage of heating is from 180° C. to 200° C.; and the fifth and final stage of heating is from 200° C. to 220° C. The reaction mixture then is held at 220° C. until a desired viscosity is reached. This holding period typically takes about 4-5 hours depending on the batch size. The reaction mixture is cooled to a discharge temperature and one can then determine the physical properties of the maleated product. Typically, the maleated product exhibits an acid number equal to 300-320 mg KOH/g and a Brookfield Viscosity (at 25° C.) of about 263 cps.

The maleated TOFA then is heated with agitation and under a nitrogen atmosphere to 120° C. Thereafter, 4.7% by weight of diethylenetriamine (DETA) is added to the reactor (establishing a DETA to TOFA mole ratio of about 1:2) and the contents of the reactor are heated to 180° C. The reactor contents are reacted at this temperature for about 2 hours. Typically, the amidated, maleated product should exhibit an acid number of about 151 mg KOH/g, an amine number of about 17 and a Brookfield Viscosity (at 25° C.) of about 4024 cps

### EXAMPLE 6

### Amidating Maleated Tall Oil Fatty Acid with EDA

To a suitable clean and dry reaction vessel, 93.0% by weight of a maleated TOFA (acid value about 316 mg KOH/g), prepared in the same manner as the maleated TOFA of Example 5, is added. The contents of the reactor are heated with agitation and under a nitrogen atmosphere to 90° C. Thereafter, 7.0% by weight of ethylenediamine (EDA) is slowly added to the reactor (establishing a EDA to TOFA mole ratio of about 0.5:1 and the contents of the reactor are heated incrementally to 150° C. over a 30 minute period of time, followed by cooling and recovery of product. Typically, the amidated, maleated product should exhibit an acid number (hydrous) of about 112 mgKOH/g, an amine number of about 6 and a Brookfield Viscosity (at 25° C.) of about 27,200 cps.

### EXAMPLE 7

### Amidating Maleated Tall Oil Fatty Acid with DETA

To a suitable clean and dry reaction vessel, 94.3% by weight of a maleated TOFA (acid value about 340 mg KOH/g) made at a fatty acid to maleic anhydride mole ratio of 1:1 in accordance with the method described above as Example 2. The contents of the reactor are heated with agitation and under a nitrogen atmosphere to about 115° C. Thereafter, 5.7% by weight of diethylenetriamine (DETA) is added to the reactor (establishing an amine to TOFA mole ratio about 0.25:1 (on a mole basis, but on an equivalent basis it is about 0.5:1) and the contents of the reactor are allowed to exotherm to 155° C. Once all of the DETA has been added, the reactor contents are heated to 180° C. and reacted at this temperature for a time sufficient to consume all of the primary amino moieties. A time of about 30-90 minutes should be sufficient in many cases. Typically, the amidated, maleated product should exhibit an acid number of about 150 mg KOH/g, an amine number of zero (0) and a Brookfield Viscosity (at 25° C.) of about 1,200,000 cps.

### EXAMPLE 8

### Amidating Maleated Tall Oil Fatty Acid with EDA

To a suitable clean and dry reaction vessel, 92.5% by weight of a maleated TOFA (acid value about 344 mg KOH/g) made at a fatty acid to maleic anhydride mole ratio of 1:1 in accordance with the method described above as Example 2. The contents of the reactor are heated with agitation and under a nitrogen atmosphere to about 70° C. Thereafter, the addition of 7.5% by weight of ethylenediamine (EDA) to the reactor was initiated. After about 5.3% of the EDA had been added, it was observed that too much cross linking had occurred and the viscosity increase in the reactor was excessive. The synthesis was aborted.

### EXAMPLE 9

### Amidating Maleated Tall Oil Fatty Acid with Tetraethylenepentamine (TEPA)

To a suitable clean and dry reaction vessel, 84.8% by weight of a maleated TOFA (acid value about 248 mg KOH/g) made according to Example 5 is added. The contents of the reactor are heated with agitation and under a nitrogen atmosphere to about 60° C. after further heating to 70° C., 15.2% by weight of tetraethylenepentamine (TEPA) is added to the reactor and the contents of the reactor are allowed to exotherm to 135° C. Once all of the TEPA has been added, the reactor contents are heated to 160° C. and reacted at this temperature for a time sufficient to consume all of the primary amino moieties. A time of about 40 to 75 minutes should be sufficient in many cases. Typically, the amidated, maleated product should exhibit an acid number of about 87 mgKOH/g, an amine number of 66.7 and a Brookfield Viscosity (at 25° C.) of about 900,000 cps.

### EXAMPLE 10

### Imidazoline Modified Maleated Tall Oil Fatty Acid

To a suitable clean and dry reaction vessel, 1474 parts by weight of a tall oil fatty acid are added. The contents of the reactor are heated with agitation and under a nitrogen atmosphere to about 60-70° C. Then, the addition of about 526 parts by weight of diethylenetriamine (DETA) is initiated. The addition rate is controlled to allow to reactor contents to exotherm to about 100° C. and then heat is applied to raise the temperature to about 115° C. Once all of the DETA has been added (occurs over a period of about 3.5 hours), the reactor contents are heated to 160° C. and reacted at this temperature for a time sufficient to achieve a constant acid value, takes about 3.25 hours. The resulting fatty imidazoline should exhibit an amine number of about 276.

To a suitable clean and dry reaction vessel, 52.1% by weight of a maleated TOFA (acid value about 312 mg KOH/g) made according to Example 2 is added. The contents of the reactor are heated with agitation under a nitrogen atmosphere to about 140° C. As additional heat is applied, 47.9% by weight of the above-produced fatty imidazoline is quickly added to the reactor. The reaction mixture is heated first to 160° C. as the fatty imidazoline is added and then to 180° C., once all of the fatty imidazoline has been added. After a reaction time of about 1.5 hours, measured from when the fatty imidazoline addition was started, a imidazoline-modified maleic anhydride maleated TOFA is recovered having an acid number of about 58 mgKOH/g, an amine number of about 31 and a Brookfield Viscosity (at 40° C.) of about 470,000 cps.

### EXAMPLE 11

### Amidating Maleated Tall Oil Fatty Acid with DETA

To a suitable clean and dry reaction vessel, 66.9% by weight of TOFA is added. The contents of the reactor are heated with agitation and under a nitrogen atmosphere to 70° C. Thereafter, 33.1% by weight of maleic anhydride (MA) and Fascat 2003 catalyst are added to the reactor (establishing a TOFA to MA mole ratio of 1:1.5) and the contents of the reactor are heated. From the starting temperature of about 70° C.; the temperature is incrementally increased until 215° C. is achieved. After each temperature adjustment and the desired set point is reached, the material is maintained at the set point temperature for a short hold period. The first stage of heating is from 70° C. to 135° C.; the second stage of heating is from 135° C. to 160° C.; the third stage of heating is from 160° C. to 180° C.; the fourth stage of heating is from 180° C. to 200° C.; and the fifth and final stage of heating is from 200° C. to 215° C. The reaction mixture then is held at 215° C. until a desired viscosity is reached. This holding period typically takes about 4-5 hours depending on the batch size.

As the maleated fatty acid composition is cooled, about 8.2%, based on the weight of the maleated TOFA composition, of diethylenetriamine (DETA) is added when the temperature reaches about 150° C., and is reacted at this temperature for a time sufficient to consume all of the primary amino moieties. Typically, the amidated, maleated product should exhibit an acid number of about 119 mg KOH/g, an amine number of 69 and a Brookfield Viscosity (at 25° C.) of about 46,200 cps.

### EXAMPLE 12

### Amidating Maleated Tall Oil Fatty Acid with DETA

To a suitable clean and dry reaction vessel, 73.7% by weight of a maleated TOFA made at a fatty acid to maleic anhydride mole ratio of 1:1 in accordance with the method described above as Example 2. The contents of the reactor are heated with agitation and under a nitrogen atmosphere to about 68° C. Thereafter, 26.3% by weight of diethylenetriamine (DETA) is added to the reactor (establishing an amine to TOFA mole ratio about 1:1 (on a mole basis) and the contents of the reactor are allowed to exotherm to 115° C. Once all of the DETA has been added, the reactor contents are heated to 160 to 170° C. and reacted at this temperature for a time sufficient to stabilize the acid value at about 8 mg KOH/g. The composition exhibits an amine number of about 276.

### EXAMPLE 13

### Amidating Maleated Tall Oil Fatty Acid with DETA

To a suitable clean and dry reaction vessel, 97.15% by weight of a maleated TOFA (acid value about 330 mg KOH/g) made at a fatty acid to maleic anhydride mole ratio of 1:1 in accordance with the method described above as Example 2. The contents of the reactor are heated with agitation and under a nitrogen atmosphere to about 110° C. Thereafter, 2.85% by weight of diethylenetriamine (DETA) is added to the reactor and the contents of the reactor are allowed to exotherm. Once all of the DETA has been added, the reactor contents are heated to 160 to 180° C. and reacted at this temperature for a time sufficient to stabilize the acid value at about 213 mg KOH/g. The composition exhibits an amine number of about zero (0) and a Bookfield viscosity of about 75,000 cps.

### EXAMPLE 14

### Amidating Maleated Tall Oil Fatty Acid with DETA

To a suitable clean and dry reaction vessel, 92.4% by weight of a maleated TOFA (acid value about 275 mg KOH/g) made at a fatty acid to maleic anhydride mole ratio of 1:1 in accordance with the method described above as Example 2. The contents of the reactor are heated with agitation and under a nitrogen atmosphere to about 120° C. Thereafter, 7.6% by weight of diethylenetriamine (DETA) is added to the reactor and the contents of the reactor are allowed to exotherm. Once all of the DETA has been added, the reactor contents are heated to 180° C. and reacted at this temperature for a time sufficient to stabilize the acid value at about 122 mg KOH/g. The composition exhibits an amine number of about 23 and a Bookfield viscosity of about 54,000 cps.

### EXAMPLE 15

### Amidating Maleated Tall Oil Fatty Acid with DETA

To a suitable clean and dry reaction vessel, 94.3% by weight of a maleated TOFA (acid value about 275 mg KOH/g) made at a fatty acid to maleic anhydride mole ratio of 1:0.5 in accordance with the method described above as Example 5. The contents of the reactor are heated with agitation and under a nitrogen atmosphere to about 120° C. Thereafter, 5.7% by weight of diethylenetriamine (DETA) is added to the reactor and the contents of the reactor are allowed to exotherm. Once all of the DETA has been added, the reactor contents are heated to about 180° C. and reacted at this temperature for a time sufficient to stabilize the acid value at about 148 mg KOH/g. The composition exhibits an amine number of about 17 and a Bookfield viscosity of about 13,000 cps.

### EXAMPLE 16

### Amidating Maleated Tall Oil Fatty Acid with DETA

To a suitable clean and dry reaction vessel, 95.7% by weight of a maleated TOFA (acid value about 275 mg KOH/g) made at a fatty acid to maleic anhydride mole ratio of 1:0.5 in accordance with the method described above as Example 5. The contents of the reactor are heated with agitation and under a nitrogen atmosphere to about 135° C. Thereafter, 4.3% by weight of diethylenetriamine (DETA) is added to the reactor and the contents of the reactor are allowed to exotherm. Once all of the DETA has been added, the reactor contents are heated to about 180° C. and reacted at this temperature for a time sufficient to stabilize the acid value at about 167 mg KOH/g. The composition exhibits an amine number of about zero (0) and a Bookfield viscosity of about 3,000 cps.

### EXAMPLE 17

### Amidating Maleated Tall Oil Fatty Acid with DETA

To a suitable clean and dry reaction vessel, 89.9% by weight of a maleated TOFA (acid value about 275 mg KOH/g) made at a fatty acid to maleic anhydride mole ratio of 1:0.5 in accordance with the method described above as Example 5. The contents of the reactor are heated with agitation and under a nitrogen atmosphere to about 130° C. Thereafter, 10.1% by weight of diethylenetriamine (DETA) is added to the reactor and the contents of the reactor are allowed to exotherm to about 150° C. at which point the DETA addition was stopped and the reactor contents are cooled to about 120° C. The DETA addition was restarted and once all of the DETA has been added, the reactor contents are heated to about 160-180° C. and reacted at this temperature for a time sufficient to stabilize the acid value at about 85 mg KOH/g. The composition exhibits an amine number of about 35 and a Bookfield viscosity of about 780,000 cps at 25° C.

### EXAMPLE 18

### Amidating Maleated Tall Oil Fatty Acid with an Amidoamine

To a suitable clean and dry reaction vessel, 73.7% by weight of a TOFA was added. The contents of the reactor are heated with agitation and under a nitrogen atmosphere to about 70° C. Thereafter, 26.3% by weight of diethylenetriamine (DETA) is gradually added to the reactor and temperature of the contents of the reactor are allowed to increase to about 115° C. at which point the DETA addition was complete (about 2 hours elapsed time). Once all of the DETA has been added, the reactor contents are heated to about 160-170° C. and reacted at this temperature for a time sufficient to stabilize the acid value at about 8.9 mg KOH/g where upon the contents of the reactor are cooled to below 100° C. The amidoamine composition exhibits an amine number of about 276 and an acid value of about 8 mg KOH/g.

To a suitable clean and dry reaction vessel, 50.8% by weight of a maleated TOFA (acid value about 330 mg KOH/g) made at a fatty acid to maleic anhydride mole ratio of 1:1 in accordance with the method described above as Example 2 was added. The contents of the reactor are heated with agitation and under a nitrogen atmosphere to about 115° C. Thereafter, 49.2% by weight of the previously prepared amidoamine is gradually added (over a period of about 40 minutes) to the reactor. The contents of the reactor are allowed to exotherm and heat is applied to gradually increase the temperature over the course of the amidoamine addition to about 160° C. After all of the amine has been added, the reactor contents are heated to about 170° C. and held at that temperature for about another hour. Following cooling, the composition exhibits an amine number of about 45, an acid value of about 52 mg KOH/g and a Bookfield viscosity of about 600,000 cps at 40° C.

### EXAMPLE 19

### Amidating Maleated Tall Oil Fatty Acid with an Amidoamine

To a suitable clean and dry reaction vessel, 47.5% by weight of a maleated TOFA (acid value about 275 mg KOH/g) made at a fatty acid to maleic anhydride mole ratio of 1:0.5 in accordance with the method described above in Example 5 was added. The contents of the reactor are heated with agitation and under a nitrogen atmosphere to about 120° C. Thereafter, 52.5% by weight of a previously prepared amidoamine (as in Example 18) is gradually added (over a period of about 40 minutes) to the reactor. The contents of the reactor are allowed to exotherm and heat is applied to gradually increase the temperature over the course of the amidoamine addition to about 150° C. After all of the amine has been added, the reactor contents are heated to about 160° C. and held at that temperature for about four hours. Following cooling, the composition exhibits an amine number of about 61, an acid value of about 28 mg KOH/g and a Bookfield viscosity of about 98,000 cps at 25° C.

### EXAMPLE 20

### Imidazoline Modified Maleated Tall Oil Fatty Acid

To a suitable clean and dry reaction vessel, 434 parts by weight of a tall oil fatty acid (XTOL® 100) are added. The contents of the reactor are heated with agitation and under a nitrogen atmosphere to about 110° C. Then, about 155 parts by weight of diethylenetriamine (DETA) is added quickly and the temperature is increased to about 150° C. Following addition of the DETA, the reactor contents are heated to 175° C. and held at about that temperature for about 1.5 hours at which point the temperature is increased to 245° C. as the evolution of water continues. After about 1.5 hours at that temperature the reaction mixture is cooled The resulting fatty imidazoline should exhibit an amine number of about 177 and an acid number of about 3 mg KOH/g.

To a suitable clean and dry reaction vessel, 52.1% by weight of a maleated TOFA (acid value about 330 mg KOH/g) made according to Example 2 is added. The contents of the reactor are heated with agitation under a nitrogen atmosphere to about 120° C. As additional heat is applied, 47.9% by weight of the above-produced fatty imidazoline is quickly added to the reactor. The reaction mixture is heated first to 160° C. as the fatty imidazoline is added and then to 180° C., once all of the fatty imidazoline has been added. After a reaction time of about 3 hours, measured from when the fatty imidazoline addition was started, a imidazoline-modified maleic anhydride maleated TOFA is recovered having an acid number of about 69 mgKOH/g, an amine number of about 18 and a Brookfield Viscosity (at 25° C.) of about 100,000 cps.

### EXAMPLE 21

### Esterifying Maleated Tall Oil Fatty Acid with Ricinoleic Acid

Maleated TOFA (559G23) used in this procedure can be prepared as follows: To a suitable clean and dry reaction vessel 74.5% by weight of TOFA and 0.2% by weight of Fascat 2003 (catalyst) are added. The contents of the reactor are heated with agitation and under a nitrogen atmosphere to 70° C. Thereafter, 25.3% by weight of maleic anhydride (MA) is added to the reactor (establishing a TOFA to MA mole ratio of 1:1) and the contents of the reactor are heated. From the starting temperature of 70° C.; the temperature is incrementally increased until 220° C. is achieved. The first stage of heating is from 70° C. to 133° C.; the second stage of heating is from 133° C. to 168° C.; the third stage of heating is from 168° C. to 205° C.; and the fourth and final stage of heating is from 205° C. to 220° C. The reaction mixture then is held at 220° C. for 5.25 hours. The reaction is cooled to a discharge temperature and one can determine the physical properties of the maleated product. Material made by the above procedure is expected to have an acid value of 315 mg KOH/g, a Brookfield viscosity (at 25° C.) of 2597 cps, and a specific gravity of 1.037.

To a suitable clean and dry reaction vessel 60.8% by weight of the above maleated TOFA and 39.2% by weight of ricinoleic acid are added. The contents of the reactor are heated with agitation and under a nitrogen atmosphere to 90° C. While the reaction mixture is held at 90° C. under nitrogen, the reaction is monitored by infrared (IR) spectroscopy to determine the disappearance of the anhydride band at 1784 cm⁻¹ and the growth of the ester band at 1732 cm⁻¹. The mixture is maintained at the reaction temperature until there is little to no change in the IR spectra of each subsequent sample taken from the reaction vessel (ca. 13 hours). The reaction is cooled to room temperature and discharged. The final product has an acid value of 222 mg KOH/g and a Brookfield viscosity (at 25° C.) of 5400 cps. IR and ¹³C nuclear magnetic resonance (NMR) spectroscopy of the final product shows that it is a mixture containing reaction products of maleated TOFA and ricinoleic acid, the inter-ester of ricinoleic acid and unreacted ricinoleic acid in the weight ratio of 0.40:0.18:0.43. Other products or residual starting materials are also likely present in the mixture but could not be quantified.

### EXAMPLE 22

### Esterifying Maleated Tall Oil Fatty Acid with Ricinoleic Acid

To a suitable clean and dry reaction vessel 60.8% by weight of maleated TOFA prepared as described above (Example 21) and 39.2% by weight of ricinoleic acid are added. The contents of the reactor are heated with agitation and under a nitrogen atmosphere to 140° C. While the reaction mixture is held at 140° C. under nitrogen, the reaction is monitored by infrared (IR) spectroscopy to determine the disappearance of the anhydride band at 1784 cm⁻¹ and the growth of the ester band at 1732 cm⁻¹. The mixture is maintained at the reaction temperature until there is little to no change in the IR spectra of each subsequent sample taken from the reaction vessel (ca. 13 hours). The reaction is cooled to room temperature and discharged. The final product is expected to have an acid value of 208 mg KOH/g and a Brookfield viscosity (at 25° C.) of 6300 cps. IR and ¹³C nuclear magnetic resonance (NMR) spectroscopy of the final product shows that it is a mixture containing reaction products of maleated TOFA and ricinoleic acid, the inter-ester of ricinoleic acid and unreacted ricinoleic acid in the weight ratio of 0.59:0.37:0.05. Other products or residual starting materials are also likely present in the mixture but could not be quantified.

As used herein, the term “acid number” is a measure of the free carboxylic acid content of a chemically modified maleated fatty acid and refers to number of milligrams (mg) of potassium hydroxide (KOH) needed to neutralize the carboxylic acid groups in one gram of chemically modified maleated fatty acid solids measured using ASTM D1980-87.

The present invention has been described with reference to specific embodiments. However, this application is intended to cover those changes and substitutions that may be made by those skilled in the art without departing from the spirit and the scope of the invention. Unless otherwise specifically indicated, all percentages are by weight. Throughout the specification and in the claims the term “about” is intended to encompass + or −5% and typically the variation is only about + or −2%.

We claim:

1. A composition comprising chemically modified, maleated unsaturated fatty acids and the salts thereof, wherein the chemical modification is selected from the group consisting of (1) esterification of the maleated unsaturated fatty acids with ricinoleic acid, (2) amidation of the maleated unsaturated fatty acids using a polyamine supplied in an amount to cause cross linking between maleated fatty acid molecules, (3) a combination of esterification and amidation of the maleated unsaturated fatty acids using an amino alcohol supplied in an amount to cause cross linking between maleated fatty acid molecules, (4) esterification of the maleated unsaturated fatty acids with an alkynyl alcohol selected from propargyl alcohol, 1-hexyn-3-ol, 5-decyne-4,7-diol, oxyalkylated propargyl alcohol and mixtures thereof, (5) amidation of the maleated unsaturated fatty acids with morpholine, (6) amidation of the maleated unsaturated fatty acids with a fatty imidazoline, (7) esterification of the maleated unsaturated fatty acids with a phosphate ester, (8) metal chelator modification, (9) reaction of the maleated unsaturated fatty acids with an amino acid, (10) xanthate modification, (11) thiophosphate ester modification, (12) hydroxamic acid modification, (13) sulfonate modification, (14) sulfate modification and combinations thereof.

2. The composition of claim 1 wherein the chemically modified, maleated unsaturated fatty acid has an acid number of at least 50 mg KOH/g before neutralization.

3. The composition of claim 1 wherein the chemically modified, maleated unsaturated fatty acid has an average molecular weight greater than about 820.

4. The composition of claim 2 wherein the chemically modified, maleated unsaturated fatty acid before neutralization has an acid value between 50 mg KOH/g and 300 mg KOH/g.

5. The composition of claim 1 wherein the maleated unsaturated fatty acid is amidated using a polyamine at a temperature between 50° C. and about 200° C.

6. The composition of claim 1 wherein the unsaturated fatty acids comprise unsaturated C₁₈ fatty acids.

7. The composition of claim 6 wherein the unsaturated fatty acids comprise a tall oil composition containing tall oil fatty acid.

8. The composition of claim 7 wherein the unsaturated fatty acids comprise a tall oil composition containing a tall oil rosin acid.

9. The composition of claim 1 wherein the maleated fatty acids have been maleated with maleic anhydride.

10. The composition of claim 9 wherein the maleated fatty acids have been maleated with from about 2% to about 25% by weight of maleic anhydride.

11. A method for reducing corrosion associated with a metal surface comprising contacting said surface with a corrosion inhibiting amount of the composition of claim 1.

12. A method for reducing corrosion associated with a metal surface comprising contacting said surface with a corrosion inhibiting amount of the composition of claim 9.

13. A method for reducing corrosion associated with a metal surface comprising contacting said surface with a corrosion inhibiting amount of the composition of claim 10.

14. A method for emulsifying a material comprising agitating the material in a suitable liquid in the presence of an emulsifying amount of the composition of claim 1.

15. A method for emulsifying a material comprising agitating the material in a suitable liquid in the presence of an emulsifying amount of the composition of claim 9.

16. A method for emulsifying a material comprising agitating the material in a suitable liquid in the presence of an emulsifying amount of the composition of claim 10.

17. A method for separating a valued material from an aqueous solution, suspension or dispersion containing the valued material comprising adding to the aqueous solution, suspension or dispersion an effective amount of the composition of claim 1.

18. A method for separating a valued material from an aqueous solution, suspension or dispersion containing the valued material comprising adding to the aqueous solution, suspension or dispersion an effective amount of the composition of claim 9.

19. A method for separating a valued material from an aqueous solution, suspension or dispersion containing the valued material comprising adding to the aqueous solution, suspension or dispersion an effective amount of the composition of claim 10.

20. A method for suppressing airborne dust comprising contacting a dust generating surface with an effective amount of the composition of claim 1

21. A method for suppressing airborne dust comprising contacting a dust generating surface with an effective amount of the composition of claim 9.

22. A method for suppressing airborne dust comprising contacting a dust generating surface with an effective amount of the composition of claim 10.

23. A method for reducing the viscosity of a cementitious slurry comprising adding an effective amount of the composition of claim 1 to the slurry.

24. A method for reducing the viscosity of a cementitious slurry comprising adding an effective amount of the composition of claim 9 to the slurry.

25. A method for reducing the viscosity of a cementitious slurry comprising adding an effective amount of the composition of claim 10 to the slurry.
